(19) United States
(12) Patent Application Publication
(10) Pub. No.: US 2016/0098426 A1
(43) Pub. Date: Apr. 7, 2016

(54) METHOD AND SYSTEM FOR PRESENTING IMAGE INFORMATION TO A USER OF A CLIENT DEVICE

(71) Applicant: YANDEX EUROPE AG, Luzern (CH)

(72) Inventors: Aleksandr Sergeevich SAYKO, Samara (RU); Boris Konstantinovich YANGEL, Nalchik, Kabardino-Balkar Republic (RU)

(21) Appl. No.: 14/890,174

(22) PCT Filed: May 16, 2014
(86) PCT No.: PCT/IB14/61500

§ 371 Date: Nov. 10, 2015

(30) Foreign Application Priority Data
May 16, 2013 (RU) PCT/RU2013/000403
Aug. 19, 2013 (RU) 2013138310

(51) Int. Cl. G06F 17/30

(52) U.S. Cl. CPC G06F 17/30247; G06F 17/30864; G06F 17/3053; G06F 17/30554

(57) ABSTRACT

Method for providing image information to a client device comprising: Receiving a search query from the client device. Effecting a search in respect of the search query. Sending to the client device search results including a group of images and another image, the group of images being selected from a plurality of groups of images stored on a server prior to having received the search query. Sending instructions to cause a display of a search engine results page (SERP) including the other image and a visual representation of the group of images. The visual representation of the group of images and the other image being displayed in an array. The visual representation of the group of images being visually distinguishable from the other image. The visual representation of the group of images including at least one image of the group of images.

### CROSS-REFERENCE

The present application claims convention priority to International Patent Application No. PCT/RU2013/000403, filed May 16, 2013, entitled “Method and System for Presenting Image Information to a User of a Client Device”; and to Russian Utility Model Application No. 2013138310, filed on Aug. 19, 2013, entitled “ [symbol] [symbol] [symbol] [symbol] [symbol] [symbol] [symbol] [symbol] ”. Both of these applications are incorporated by reference herein in their entirety.

### FIELD

The present technology relates to methods and systems for presenting image information to a user of a client device.

### BACKGROUND

The Internet provides access to a wide variety of resources, for example, video files, image files, audio files, or Web pages, including content for particular subjects, book articles, or news articles. A search engine can select one or more resources in response to receiving a search query. A search query is data that a user submits to (or causes, knowingly or unknowingly, to be submitted to or obtained by) a search engine to conduct a search to satisfy the user's informational needs. Search queries almost always include data in the form of text—e.g., one or more search query terms—as well as other information. The search engine selects and scores resources based on their relevance to the search query and on their importance relative to other resources to provide search results that link to the selected resources. The search results are typically ordered according to the scores and presented according to this order on what is known in the art as “search engine results page” (SERP).

Some search engines specialize in image searching. Other search engines allow a user to obtain search results that only contain images. This can be done by the user indicating that the search results should only contain images when submitting the search query or by the user requesting that the search results be narrowed to only contain images once an initial general search result has been presented on the SERP. Conventionally images being part of the image-only search results are presented in thumbnail format in an array on the SERP. In such an array the images may be presented as a series of thumbnails in defined rows (with no defined columns), a series of thumbnails in defined columns (with no defined rows), or a series of thumbnails in defined columns and rows. If the user desires to navigate to the Internet resource where a particular image shown in the thumbnail format in the image array is located, he or she will select the image (e.g. by “clicking” on the image). The thumbnail of the image is typically associated with a hyperlink to the Internet resource and thus the user will be redirected to the resource itself. For example, a web page containing the image from which the thumbnail was taken will open, displaying the image (and any other information on that page).

A typical search for images may result in hundreds of thumbnails of images being displayed in the SERP. The user thus has to go through a large number of thumbnails in order to locate one or more images that suit his or her needs. This makes image searching time consuming even with the assistance of current search engines.

Furthermore, users sometimes want to see many different images of the same thing. For example, users may want to see many images that offer step-by-step instructions on how to do or make something, or to chronicle a particular event, or to have different views of the same object. Although all the images desired by the user may appear in the SERP of a typical search engine, these images would be scattered around the SERP as the images are typically sorted by relevancy score. Additionally, certain search queries can yield images in the SERP that of very different things. For example, searching for images for “apple” can show in the same SERP images of the apple fruit, images of a company logo, and images of this company's products. Since the images are arranged according to relevancy, the SERP could show for example three images of the fruit, followed by five images of the company logo, followed by two more images of the fruit, and then an image of one of the company's products. As could be understood, this could lead to a certain frustration to a user looking only for images of the fruit. Also, even by refining the search terms used, the results may still be disparate. For example, refining the search query to search for “apple fruit” can show in the same SERP images of a whole apple alone, a sliced apple, apples in an apple tree, red apples, green apples, drawings of apples, and apple based products.

Therefore, there is a need for a system and method for presenting image information to a user of a client device that presents the results of an image search that does not only take into account the relevancy of the images.

### SUMMARY

It is an object of the present technology to ameliorate at least one of the inconveniences present in the prior art, be it one mentioned above or otherwise.

It is also an object of the present technology to provide a system and method for presenting image information to a user of a client device that presents the results of an image search that does not only take into account the relevancy of the images. Hence, in the present technology, in response to a search query for images by a user, search results are received which include one or more groups of images. The groups are selected from groups of images stored on a server prior to the search query of the user. The SERP then displays individual images (i.e. images that are not part of a group), if any, and a visual representation of the one or more groups of images in an array. The visual representation of the one or more groups of images on the SERP is such that the user can visually differentiate groups of images from individual images, if any, and from other groups of images, if any. The visual representation of a group of images includes at least one image of the group of images.

By displaying a visual representation of one or more groups of images to the user on the SERP, the user can select multiple images of the search results. By grouping at least some of the images of the search results prior to the search query being made, retrieval of the search results in order to display a SERP including one or more groups of images may be done more quickly than if the images are grouped following the search query.

Thus, in one aspect, some implementations of the present technology provide a method for providing image information for display to a user of a client device comprising: (I) Receiving, by at least one server from the client device via a communications network, a search query. (II) Effecting, by the at least one server, a search in respect of the search query. (III) Sending, by the at least one server to the client device via the communications network, search results in respect of the search query, the search results including a group of images and at least one other image, the group of images being selected from a plurality of groups of images stored on the at least one server prior to having received the search query (IV) Sending, by the at least one server to the client device, instructions to cause a display to the user via a user interface of the client device of a search engine results page (SERP) including the at least one other image and a visual representation of the group of images. The visual representation of the group of images and the at least one other image are displayed in an array. The visual representation of the group of images is visually distinguishable on the user interface of the client device from the at least one other image. The visual representation of the group of images includes at least one image of the group of images.

In some implementations, wherein each of the plurality of groups of images stored on the at least one server includes a plurality of similar images selected from images stored on the at least one server prior to having received the search query. In some implementations, the images stored on the at least one server have been retrieved from Internet resources. In some implementations, the at least one other image is selected from the images stored on the at least server prior to having received the search query. In some implementations, each image of the images stored on the at least one server prior to having received the search query has an image identification number; and identical images have a common image identification number. In some implementations, each of the plurality of groups of images has a group identification number; and each group identification number has a plurality of corresponding image identification numbers. In some implementations, the images stored on the at least one server are stored as thumbnails. In some implementations, images stored on the at least one server are stored with metadata associated with the images.

In some implementations, the at least one image of the group of images is displayed as a thumbnail.

In some implementations, wherein the group of images is a plurality of groups of images, the visual representation of each of the plurality of groups of images being visually distinguishable on the user interface of the client device from the visual representation of a remainder of the plurality of groups of images.

In some implementations, wherein the at least one other image is at least one individual image. In some implementations, wherein the at least one individual image is displayed as a thumbnail in the array on the user interface of the client device. In some implementations, a color of the visual representation of the group of images around the at least one image of the group of images differs from a color around the at least one individual image on the SERP. In some implementations, the at least one image of the group of images is at least two images of the group of images; the at least one individual image is at least two individual images; and a spacing between the at least two images of the group of images differs from a spacing between the at least two individual images.

In some implementations, the at least one other image is at least one other group of images selected from the plurality of groups of images stored on the at least one server prior to having received the search query, the at least one other group of images having a visual representation being visually distinguishable on the user interface of the client device from the visual representation of the group of images.

In some implementations, the images of the group of images are visually similar In some implementations, the images of the group of images have a similar color histogram. In some implementations, the images of the group of images have a similar histogram of gradient.

In some implementations, the images of the group of images have similar prevailing colors. In some implementations, wherein the images of the group of images have similar prevailing colors.

In some implementations, the images of the group of images are of similar size and proportion.

In some implementations, images of the group of images are from a single web page. In some implementations, the visual representation of the group of images includes a hyperlink to the single web page. In some implementations, the single web page has a geographical correspondence to a geographical location associated with the user interface of the client device.

In some implementations, visual representation of the group of images displays less images than a number of images present in the group of images. In some implementations, the visual representation of the group of images includes an indication of the number of images present in the group of images.

In some implementations, the group of images includes at least four images.

In some implementations, wherein the visual representation of the group of images includes a banner displaying information associated with the images of the group of images.

In some implementations, wherein the at least one image of the group of images is at least two images of the group of images displayed as thumbnails. In some implementations, wherein the at least two images are disposed side-by-side in a row. In some implementations, the at least two images of the group of images is at least three images of the group of images disposed in a tiled array. In some implementations, one of the at least two images is completely shown and other images of the at least two images are partially hidden by at least one of: the one of the at least two images, and another of the other images of the at least two images. In some implementations, the at least two images are arranged in a logical sequence in the visual representation.

In some implementations, the images of the group of images are ranked; and the at least one image of the group of images of the visual representation of the group of images includes an image of the group of images having a highest rank.

In some implementations, wherein sending, by the at least one server to the client device via the communications network, the search results in respect of the search query includes: sending, by the at least one server to the client device via the communications network, the search results in respect of the search query sorted by relevancy factor.

In some implementations, a method of the present aspect further comprises sending, by the at least one server to the client device via the communications network, instructions to cause a change in the display of the visual representation of the group of images via the user interface of the client device to include a display of an expanded version of the group of images having been selected by the user, without leaving the SERP. In some implementations, the expanded version of the visual representation of the group of images includes at least one of the images of the group of images in full. In some implementations, the expanded version of the visual representation of the group of images at least partially overlaps at least one of the at least one other image.

In some implementations, the visual representation of the group of images is a first visual representation of the group of images; and a method of the present aspect further comprises, upon receiving by the at least one server via the communications network an indication of selection of the group of images by the user on the user interface of the client device, sending, by the at least one server to the client device via the communications network, instructions to cause a display to the user via the user interface of the client device a second visual representation of the group of images without leaving the SERP. The second visual representation of the group of images being larger in size than the first visual representation of the group of images.

In some implementations, the search results are based at least in part on metadata and image data associated with images searched by the at least one server.

In some implementations, the at least one other image is at least one first other image; and the search results further include at least one second other image, the at least one second other image not being displayed on the SERP.

In another aspect, some implementations of the present technology provide a method of presenting image information to a user of a client device comprising: (I) receiving, from the user via a user interface of the client device, a search query; (II) sending, from the client device to at least one server via a communications network, the search query; (III) receiving, from the at least one server by the client device via the communications network, search results in respect of the search query, the search results including a group of images and at least one other image, the group of images being selected from a plurality of groups of images stored on the at least one server prior to having received the search query; (IV) displaying, to the user via the user interface of the client device, a search engine results page (SERP) including the at least one other image and a visual representation of the group of images. The visual representation of the group of images and the at least one other image are displayed in an array. The visual representation of the group of images is visually distinguishable on the user interface of the client device from the at least one other image. The visual representation of the group of images includes at least one image of the group of images.

In some implementations, each of the plurality of groups of images stored on the at least one server includes a plurality of similar images selected from images stored on the at least one server prior to having received the search query. In some implementations, the images stored on the at least one server have been retrieved from Internet resources. In some implementations, the at least one other image is selected from the images stored on the at least server prior to having received the search query. In some implementations, each image of the images stored on the at least one server prior to having received the search query has an image identification number; and identical images have a common image identification number. In some implementations, each of the plurality of groups of images has a group identification number; and each group identification number has a plurality of corresponding image identification numbers. In some implementations, the images stored on the at least one server are stored as thumbnails. In some implementations, images stored on the at least one server are stored with metadata associated with the images.

In some implementations, the at least one image of the group of images is displayed as a thumbnail.

In some implementations, the group of images is a plurality of groups of images, the visual representation of each of the plurality of groups of images being visually distinguishable on the user interface of the client device from the visual representation of a remainder of the plurality of groups of images.

In some implementations, the at least one other image is at least one individual image. In some implementations, the at least one individual image is displayed as a thumbnail in the array on the user interface of the client device. In some implementations, a color of the visual representation of the group of images around the at least one image of the group of images differs from a color around the at least one individual image on the SERP. In some implementations, the at least one image of the group of images is at least two images of the group of images; the at least one individual image is at least two individual images; and a spacing between the at least two images of the group of images differs from a spacing between the at least two individual images.

In some implementations, the at least one other image is at least one other group of images selected from the plurality of groups of images stored on the at least one server prior to having received the search query, the at least one other group of images having a visual representation being visually distinguishable on the user interface of the client device from the visual representation of the group of images.

In some implementations, the images of the group of images are visually similar In some implementations, the images of the group of images have a similar color histogram. In some implementations, wherein the images of the group of images have a similar histogram of gradient. In some implementations, the images of the group of images have similar prevailing colors. In some implementations, the images of the group of images have similar prevailing colors. In some implementations, the images of the group of images are of similar size and proportion.

In some implementations, images of the group of images are from a single web page. In some implementations, the visual representation of the group of images includes a hyperlink to the single web page. In some implementations, the single web page has a geographical correspondence to a geographical location associated with the user interface of the client device.

In some implementations, the visual representation of the group of images displays less images than a number of images present in the group of images. In some implementations, the visual representation of the group of images includes an indication of the number of images present in the group of images.

In some implementations, the group of images includes at least four images.

In some implementations, the visual representation of the group of images includes a banner displaying information associated with the images of the group of images.

In some implementations, the at least one image of the group of images is at least two images of the group of images displayed as thumbnails. In some implementations, the at least two images are disposed side-by-side in a row. In some implementations, the at least two images of the group of images is at least three images of the group of images disposed in a tiled array. In some implementations, one of the at least two images is completely shown and other images of the at least two images are partially hidden by at least one of: the one of the at least two images, and another of the other images of the at least two images. In some implementations, the at least two images are arranged in a logical sequence in the visual representation.

In some implementations, the images of the group of images are ranked; and the at least one image of the group of images of the visual representation of the group of images includes an image of the group of images having a highest rank.

In some implementations, receiving, from the at least one server by the client device via the communications network, the search results in respect of the search query includes: receiving, from the at least one server by the client device via the communications network, the search results in respect of the search query sorted by relevancy factor.

In some implementations, a method of the present aspect further comprises upon receiving an indication of selection from the user of the group of images, expanding the visual representation of the group of images without leaving the SERP. In some implementations, expanding the visual representation of the group of images includes expanding the visual representation of the group of images to display in full at least one of the images of the group of images. In some implementations, expanding the visual representation of the group of images includes expanding the visual representation of the group of images to at least partially overlap at least one of the at least one other image.

In some implementations, the visual representation of the group of images is a first visual representation of the group of images; and a method of the present aspect further comprises upon receiving an indication of selection from the user of the group of images, displaying a second visual representation of the group of images without leaving the SERP. The second visual representation of the group of images is larger in size than the first visual representation of the group of images.

In some implementations, the search results are based at least in part on metadata and image data associated with images searched by the at least one server.

In some implementations, the at least one other image is at least one first other image; and the search results further include at least one second other image, the at least one second other image not being displayed on the SERP.

In yet another aspect, some implementations of the present technology provide a system for providing image information for display to a user of a client device comprising: (I) A search query reception component for receiving, by at least one server from the client device via a communications network, a search query. (II) A search component for effecting, by the at least one server, a search in respect of the search query. (III) A search results dispatch component for sending, by the at least one server to the client device via the communications network, search results in respect of the search query, the search results including a group of images and at least one other image, the group of images being selected from a plurality of groups of images stored on the at least one server prior to having received the search query. (IV) A search engine results page (SERP) dispatch component for sending, by the at least one server to the client device, instructions to cause a display to the user via a user interface of the client device of a SERP including the at least one other image and a visual representation of the group of images. The visual representation of the group of images and the at least one other image are displayed in an array. The visual representation of the group of images is visually distinguishable on the user interface of the client device from the at least one other image. The visual representation of the group of images including at least one image of the group of images.

In some implementations, each of the plurality of groups of images stored on the at least one server includes a plurality of similar images selected from images stored on the at least one server prior to having received the search query. In some implementations, images stored on the at least one server have been retrieved from Internet resources. In some implementations, the at least one other image is selected from the images stored on the at least server prior to having received the search query. In some implementations, each image of the images stored on the at least one server prior to having received the search query has an image identification number; and identical images have a common image identification number. In some implementations, each of the plurality of groups of images has a group identification number; and each group identification number has a plurality of corresponding image identification numbers. In some implementations, the images stored on the at least one server are stored as thumbnails. In some implementations, the images stored on the at least one server are stored with metadata associated with the images.

In some implementations, the at least one image of the group of images is displayed as a thumbnail.

In some implementations, the group of images is a plurality of groups of images, the visual representation of each of the plurality of groups of images being visually distinguishable on the user interface of the client device from the visual representation of a remainder of the plurality of groups of images.

In some implementations, the at least one other image is at least one individual image. In some implementations, the at least one individual image is displayed as a thumbnail in the array on the user interface of the client device. In some implementations, a color of the visual representation of the group of images around the at least one image of the group of images differs from a color around the at least one individual image on the SERP. In some implementations, the at least one image of the group of images is at least two images of the group of images; the at least one individual image is at least two individual images; and a spacing between the at least two images of the group of images differs from a spacing between the at least two individual images.

In some implementations, the at least one other image is at least one other group of images selected from the plurality of groups of images stored on the at least one server prior to having received the search query, the at least one other group of images having a visual representation being visually distinguishable on the user interface of the client device from the visual representation of the group of images.

In some implementations, the images of the group of images are visually similar In some implementations, the images of the group of images have a similar color histogram. In some implementations, the images of the group of images have a similar histogram of gradient. In some implementations, the images of the group of images have similar prevailing colors. In some implementations, the images of the group of images have similar prevailing colors. In some implementations, the images of the group of images are of similar size and proportion.

In some implementations, images of the group of images are from a single web page. In some implementations, the visual representation of the group of images includes a hyperlink to the single web page. In some implementations, the single web page has a geographical correspondence to a geographical location associated with the user interface of the client device.

In some implementations, the visual representation of the group of images displays less images than a number of images present in the group of images. In some implementations, the visual representation of the group of images includes an indication of the number of images present in the group of images. In some implementations, the group of images includes at least four images. In some implementations, the visual representation of the group of images includes a banner displaying information associated with the images of the group of images.

In some implementations, the at least one image of the group of images is at least two images of the group of images displayed as thumbnails. In some implementations, the at least two images are disposed side-by-side in a row. In some implementations, the at least two images of the group of images is at least three images of the group of images disposed in a tiled array. In some implementations, one of the at least two images is completely shown and other images of the at least two images are partially hidden by at least one of: the one of the at least two images, and another of the other images of the at least two images. In some implementations, the at least two images are arranged in a logical sequence in the visual representation.

In some implementations, the images of the group of images are ranked; and the at least one image of the group of images of the visual representation of the group of images includes an image of the group of images having a highest rank.

In some implementations, the search results dispatch component is for sending, by the at least one server to the client device via the communications network, the search results in respect of the search query sorted by relevancy factor.

In some implementations, a system of the present aspect further comprises a SERP display alteration component for sending, by the at least one server to the client device via the communications network, instructions to cause a change in the display of the visual representation of the group of images via the user interface of the client device to include a display of an expanded version of the group of images having been selected by the user, without leaving the SERP. In some implementations, the expanded version of the visual representation of the group of images includes at least one of the images of the group of images in full. In some implementations, the expanded version of the visual representation of the group of images at least partially overlaps at least one of the at least one other image.

In some implementations, the visual representation of the group of images is a first visual representation of the group of images; and a system of the present aspect further comprises a SERP display alteration component for sending, by the at least one server to the client device via the communications network, instructions to cause a display to the user via the user interface of the client device a second visual representation of the group of images without leaving the SERP upon receiving by the at least one server via the communications network an indication of selection of the group of images by the user on the user interface of the client device. The second visual representation of the group of images being larger in size than the first visual representation of the group of images.

In some implementations, the search results are based at least in part on metadata and image data associated with images searched by the at least one server.

In some implementations, the at least one other image is at least one first other image; and the search results further include at least one second other image, the at least one second other image not being displayed on the SERP.

In the context of the present specification, a “server” is a computer program that is running on appropriate hardware and is capable of receiving requests (from client devices) over a network, and carrying out those requests, or causing those requests to be carried out. The hardware may be one physical computer or one physical computer system, but neither is required to be the case with respect to the present technology. In the present context, the use of the expression “at least one server” is not intended to mean that every task (e.g. received instructions or requests) or any particular task will have been received, carried out, or caused to be carried out, by the same server (i.e. the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, “a client device” is any computer hardware that is capable of running software appropriate to the relevant task at hand. Thus, some (non-limiting) examples of client devices include personal computers (desktops, laptops, netbooks, etc.), smartphones, and tablets.

In the context of the present specification, a “database” is any structured collection of data, irrespective its particular structure, database management software, or computer hardware on which the data is stored, implemented or otherwise rendered available for use. A database is in “operational communication” in the present context when it is rendered available for use as part of a database management system that is itself connected to an accessible communications network.

In the context of the present specification, the expression “component” is meant include software (appropriate to a particular hardware context) that is both necessary and sufficient to achieve the specific function(s) being referenced.

In the context of the present specification, the expression “tangible computer readable storage medium” is intended to include media of any nature and kind whatsoever, including RAM,

ROM, disks (CD-ROMs, DVDs, floppy disks, hard drivers, etc.), USB keys, solid state-drives, tape drives, etc.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first server” and “third server” is not intended to imply any particular order, type, chronology, hierarchy or ranking (for example) of/between the servers, nor is their use (by itself) intended to imply that any “second server” must necessarily exist in any given situation.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present invention, as well as other aspects and further features thereof, reference is made to the following description which is to be used in conjunction with the accompanying drawings, where:

FIG. 1 is a schematic illustration of a computer system being an implementation of the present technology;

FIG. 2A is an exemplary image retrieved by a server of the system of FIG. 1;

FIG. 2B is a schematic representation of an analysis performed on the image of FIG. 2A and of information associated with the image obtained by the server;

FIG. 3 is a schematic representation of a method for grouping images using the system of FIG. 1;

FIG. 4 is a flow chart showing a procedure for using the system of FIG. 1;

FIG. 5 is a representation of a search engine page to be displayed on and used by a client device;

FIG. 6A is an embodiment of a SERP displayed on the client device in response to a search query;

FIG. 6B is a modified display of the SERP of FIG. 6A;

FIG. 6B is another modified display of the SERP of FIG. 6A;

FIG. 7A is an alternative embodiment of a SERP displayed on the client device in response to a search query;

FIG. 7B is a modified display of the SERP of FIG. 7A;

FIG. 8A is another alternative embodiment of a SERP displayed on the client device in response to a search query;

FIG. 8B is a modified display of the SERP of FIG. 8A;

FIG. 9 is another alternative embodiment of a SERP displayed on the client device in response to a search query;

FIG. 10 is another alternative embodiment of a SERP displayed on the client device in response to a search query;

FIG. 11 is another alternative embodiment of a SERP displayed on the client device in response to a search query;

FIG. 12 is another alternative embodiment of a SERP displayed on the client device in response to a search query;

FIG. 13 is another alternative embodiment of a SERP displayed on the client device in response to a search query;

FIG. 14 is another alternative embodiment of a SERP displayed on the client device in response to a search query; and

FIG. 15 is another alternative embodiment of a SERP displayed on the client device in response to a search query.

### DETAILED DESCRIPTION

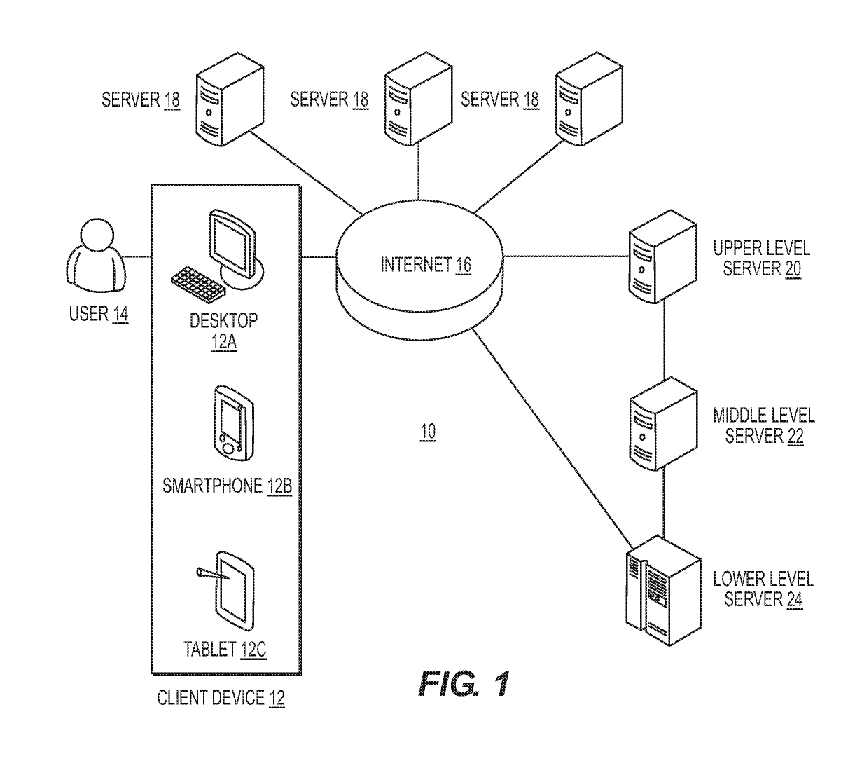

Referring to FIG. 1, there is shown a computer system 10 comprising implementations of the present technology. It is to be expressly understood that the computer system 10 is merely one implementation of the present technology. The description thereof that follows is intended to be only a description of an illustrative example of the present technology. This description is not intended to define the scope or set forth the bounds of the present technology. In some cases, what are believed to be helpful examples of modifications to the computer system 10 may also beset forth hereinbelow. This is done merely as an aid to understanding, and, again, not to define the scope or set forth the bounds of the present technology. These modifications are not an exhaustive list, and, as a person skilled in the art would understand, other modifications are likely possible. Further, it should not be interpreted that where this has not been done (i.e. where no examples of modifications have been set forth), that no modifications are possible and/or that what is described is the sole manner of implementing that element of the present. As a person skilled in the art would understand, this is likely not the case. In addition it is to be understood that the computer system 10 provides a simple implementation of the present technology, which is presented in this manner as an aid to understanding. As persons skilled in the art would understand, most implementations of the present technology would be of a greater complexity.

The computer system 10 includes a client device 12 to be used by a user 14. The client device 12 can be any one of the three client devices 12 illustrated in FIG. 1, namely a desktop computer 12A, such as an iMac™, a smartphone 12B, such as an iPhone™ 4S™, and a tablet computer 12C, such as an iPad™. In other implementations, client devices may include other makes and/or models of smartphone, tablet computer, e-reader, laptop computer, desktop computer, personal digital assistant, or another Internet-enabled device. Client device 12 is in communication with the Internet 16 (which may, depending on particular circumstances be via mobile telephony network, a WiFi network, or a Bluetooth™ connection). The client device 12 has installed thereon a web browser application, such as Safari™, which forms part of a user interface of the client device 12. It is contemplated that other web browsers and/or other Internet-enabled applications may also be installed thereon. Although only a single client device 12 is shown (the user 14 uses one of the client devices 12A, 12B, 12C), it is contemplated that multiple client devices could be used in the system 10.

The computer system 10 also includes a number of servers 18 in communication with the Internet 16. Only three servers 18 are illustrated for simplicity, but is should be understood that more (and less) than three servers 18 are contemplated. For example, it is contemplated that the system 10 could include all of the servers 18 connected to the internet. It is also contemplated that only servers 18 in a particular geographical location could be included in the system 10. The servers 18 each host one or more web pages that can be accessed by the client device 12 via the Internet 16. Many of these web pages contain images.

The computer system 10 also includes search engine servers, which include an upper level server 20, a middle level server 22 and a lower level server 24. As can be seen, the upper level server 20 and the lower level server 24 communicate with the Internet 16. The middle level server 22 communicates with the upper and lower level servers 20, 24. For simplicity, only one of each type of server 20, 22, and 24 is shown and described, but it is contemplated that the computer system 10 could include more than one of each type of server 20, 22 and 24. It is also contemplated the functions of the upper, middle and lower servers 20, 22, 24 could be combined so as to be accomplished by one or two servers or could be further split up so as to be accomplished by more than three servers.

It is contemplated that instead of communicating via the Internet 16, that the client device 12 and the servers 18, 20 and 24 could communicate via another type of communication network. Examples of alternative communication networks include, but are not limited to, a local area network (LAN), a wide area network, and an intranet.

As will be described in greater detail below, in order to perform an image search, the user 14 enters, via the user interface of the client device 12, a search query corresponding to the type of images desired. The client device 12 then sends the search query via the Internet 16 to the servers 20, 22, 24 which together perform a search of images retrieved from web pages hosted by the servers 18 via the Internet 16, sort the search results and send instructions back to the client device 12 via the Internet 16 to display a search engine results page (SERP). The client device 12 receives these instructions and displays the SERP to the user 14 on a screen of the client device 12. The SERP includes thumbnails of images resulting from the search query that the user 14 can scroll through to find one or more desired images and, if desired, access the web page from which one or more images were retrieved.

The computer system 10 includes a database of images and associated information on the lower level server 24. As will be described in greater detail below, when performing a search for images in response to a search query, the computer system 10 searches this database on the lower level server 24 and not the servers 18 hosting web pages directly.

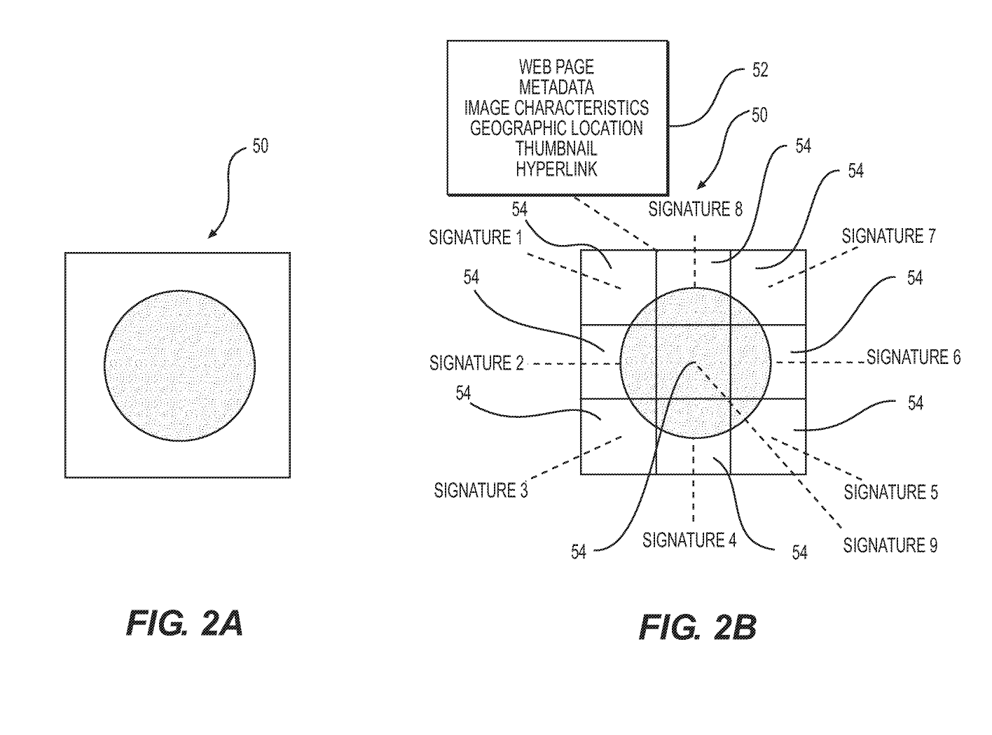

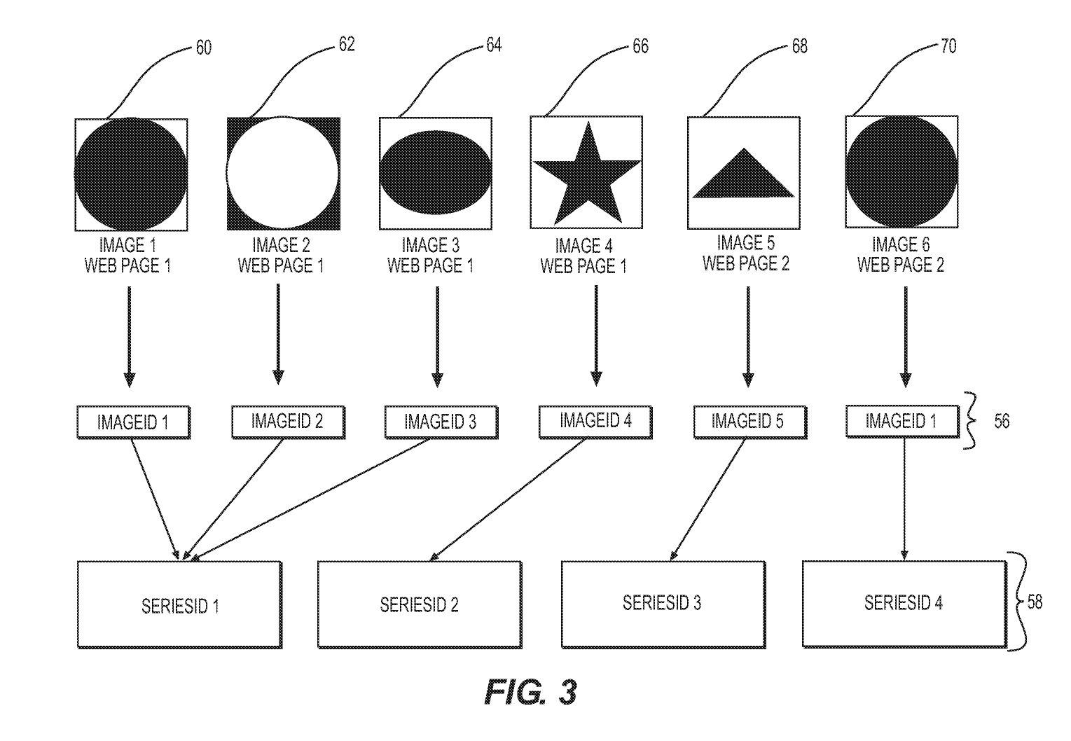

With reference to FIGS. 2A to 3, the manner in which the database is populated and images sorted thereon will be described. Web crawlers, also known as web spiders, visit web pages hosted by the servers 18 in order to find images. In one embodiment, in order to provide an enjoyable user experience, although the web crawlers visit web pages containing adult-related content, computer viruses, pop-up advertising, spam, malware or a lot of advertising, images retrieved from such web pages will not be included in the search results provided to the user. It is also contemplated that the web crawlers could ignore images that are considered too small In one example, the web crawlers ignore images that are smaller than 10 pixels by 10 pixels. It is contemplated however, that the web crawlers could retrieve images from any web page and of any size. When a web crawler identifies an image such as the image 50 in FIG. 2A, the lower level server 24 saves in the database of the lower level server 24 a thumbnail of the image 50 and data 52 associated with the image 50. It is contemplated that instead of saving a thumbnail of the image 50, the lower level server 24 could save the complete image 50. As can be seen in FIG. 2B, the data 52 associated with the image 50 includes the web address (unified resource locator (URL)) of the web page where the image 50 is located, metadata associated with the image 50, the geographic location associated with the web page where the image 50 is located, and a hyperlink to the image 50. The metadata associated with the image 50 can include one or more of the name of the author or photographer of the image 50, the date of creation, modification or upload of the image 50, and keywords associated with the image 50.

The data 52 also includes image characteristics. One such image characteristic is the image size. The image size is typically consists of a height and width of an image in terms of pixels, but it is contemplated that it could also be in terms of centimeters, inches, or any other unit of measure. The lower level server 24 also makes an analysis of the image 50. To do so, the image 50 is first separated in a number of cells 54. In the example shown in FIG. 2B, the image 50 has been separated in nine cells 54. It is contemplated that for increased accuracy, the image 50 could be separated into more than nine cells 54. Then for each cell 54, the lower lever server 24 determines the color histogram, the histogram of gradient (HOG) and the prevailing colors. These three combined elements form the image signature for each cell 54 of the image 50 (i.e. signatures 1 to 9). The color histogram is a representation of the number of pixels in a cell 54 that are within multiple ranges of colors. For example, the color histogram could represent the number of red, green and blue pixels in a cell 54. As would be understood, the color histogram in order to be more accurate could represent the number of pixels within ranges of various shades of red, green and blue in a cell 54. The HOG is a representation of the variations in intensity of the colors in a cell 54. It is contemplated that one or more of the image size, color histogram, HOG and prevailing colors could be omitted. It is also contemplated that other image characteristics and image analysis methods could be used.

The above data 52 is saved in the database of the lower level sever for every image found by the web crawlers. It is contemplated that not all of the above-mentioned data 52 could be saved in the database of the lower level server 24 and be associated with the images found by the web crawlers. It is also contemplated that additional and alternative data could be saved in the database of the lower level server 24 and be associated with the images found by the web crawlers.

Once an image has been analysed and its data saved in the database of the lower level server 24, it is assigned an image identification number 56 and group identification number 58. FIG. 3 schematically illustrates the manner in which these numbers 56, 58 are assigned for six images 60, 62, 64, 66, 68 and 70 that have been found by the web crawlers. In the example of FIG. 3, images 60, 62, 64 and 66 are hosted on the same web page (i.e. web page 1) and images 68 and 70 are both hosted on another web page (i.e. web page 2).

By comparing the image characteristics of the images 60, 62, 64, 66, 68 and 70, the lower level server 24 determines that the images 60, 62, 64, 66 and 68 are all different from each other and that image 70 is identical to image 60. As a result, the lower level server 24 assigns the same image identification number 56 to images 60 and 70 (i.e. ImageID 1) and images 62, 64, 66 and 68 are assigned different image identification numbers 56 (i.e. ImageID 2 to 5 respectively). Each image identification number 56 is associated with the data 52 of its corresponding image 60, 62, 64, 66, 68 or 70. In the case of the image identification number ImageID 1, since it is associated with two images (i.e. images 60 and 70), the data 52 of both images is associated with this image identification number 56. In the event that a web crawler should find another image, this other image would be assigned a new (different) image identification number 56 if it differs from any of the images associated with identification numbers 56 already in the database or would be assigned an existing image identification number 56 if it is identical to an image associated with an identification number 56 already in the database.

Once an image has been assigned an image identification number 56, it is then assigned a group identification number 58 in order to form groups of images. In the present implementation, the grouping of images is based on two main factors: the web page from which an image has been retrieved and the visual similarity between images retrieved from this web page. As such, images that are visually similar and that are from the same web page are placed in the same group and their image identification numbers 56 are associated with the same group identification number 58 (SeriesID). To determine if two images are similar, an algorithm compares the image characteristics of the two images for the images as a whole or for each corresponding cells 54 and if these characteristics fall within predetermined levels, the images are considered similar. Many different algorithms exists which are contemplated to determine the similarity of two images. Examples of such algorithms include, but are not limited to, distance measuring techniques such as the Manhattan distance and the Euclidean distance. For example, if the sizes and proportions of two images of are within 10 percent of each other and the image signatures (i.e. color histogram, HOG, prevailing colors) of each corresponding pairs of cells 54 match at 75 percent or more for at least 75 percent of the corresponding pairs of cells 54, then the images are considered similar. The previous example is intended as a non-limiting example for ease of understanding. Other methods and values are contemplated. In another method, vectorized representations of the images are formed based on the images' features (i.e. one or more of color histogram, HOG, prevailing colors, etc.), a distance function is calculated in that vector space, and then metrics are used to determine similar images. As would be understood, by increasing the value of correspondence between the corresponding image signatures of two images, the level of similarity between the images in order for them to be considered similar by the algorithm has to be higher.

Returning to the example of FIG. 3, the manner in which the six images 60, 62, 64, 66, 68 and 70 are assigned to a group having a corresponding group identification number 58 will be described. The image 60 being the first image, its image identification number “Image ID 1” of the image 60 is associated with a first group of images assigned the group identification number “Series ID 1”. The image 62 has the same geometry as the image 60 (i.e. both are circles of the same size), but in the image 62, the circle is white on a black background, and in the image 60, the circle is black on a white background. Even though they are not identical, for purposes of the present example, the images 60 and 62 are considered to be similar. As the images 62 and 60 are also from the same web page (i.e. web page 1), the image identification number “Image ID 2” of the image 62 is also associated with the group of images having the group identification number “Series ID 1”. The image 64 shows a black ellipse on a white background which, for purposes of the present example, is also considered to be similar to the image 60. As the images 64 and 60 are also from the same web page (i.e. web page 1), the image identification number “Image ID 3” of the image 64 is also associated with the group of images having the group identification number “Series ID 1”. The image 66 shows a black star on a white background which, for purposes of the present example, is considered not to be similar to any of the previous images 60, 62, and 64. As such, even if the image 66 is from the same web page as the images 60, 62 and 64, it is not associated with the group of images having the group identification number “Series ID 1”. Instead, the image identification number “Image ID 4” of the image 66 is associated with a group of images having the group identification number “Series ID 2”. The image 68, for purposes of the present example, is considered to not be similar to the previous images 60, 62, 64 and 66 and is also not from the same web page. For this reason, the image identification number “Image ID 5” of the image 68 is associated with a group of images having the group identification number “Series ID 3”. The image 70 is from the same web page as the image 68, but since, for purposes of the present example, it is not similar to the image 68, the image identification number “Image ID 1” of the image 70 is not associated with the group of images having the group identification number “Series ID 3”. The image 70 is identical to the image 60, and therefore shares the same image identification number Image ID 1 as mentioned above, however the image 70 is from a different web page. As a result, the image identification number “Image ID 1” in addition to being associated with the group of images having the group identification number “Series ID 1” because it is hosted on the web page “web page 1”, is also associated with a group of images having the group identification number “Series ID 4” because it is hosted on the web page “web page 2”.

It is contemplated that alternative or additional criteria could be used to form the group of images. For example, the images could form groups based on keywords associated with the images as part of their metadata. It is also contemplated that one of the above two criteria could also be omitted. For example, all images from a common web page could be part of the same group regardless of their similarities (or lack thereof). Images in the present implementation can form a group only if they are from a single source, this source being a web page. However, sources other than web pages are contemplated. For example, it is contemplated that images could be part of the same group if they originate from the same database, the same server, or from different web pages that share the same domain name or the same author(s).

Turning now to FIGS. 1 and 4 to 6C, a method of presenting image information to the user 14 of the client device 12 and a method 100 of providing this image information for display to a user 14 of the client device 12 will be described. As the steps of the method of presenting image information cause steps of the method 100 to be initiated or are initiated in response to steps of the method 100, the two methods will be described together. Steps occurring on the client device relate to the method of presenting image information to the user 14 and steps occurring on the server 20, 22, 24 relate to the method 100 of providing this image information.

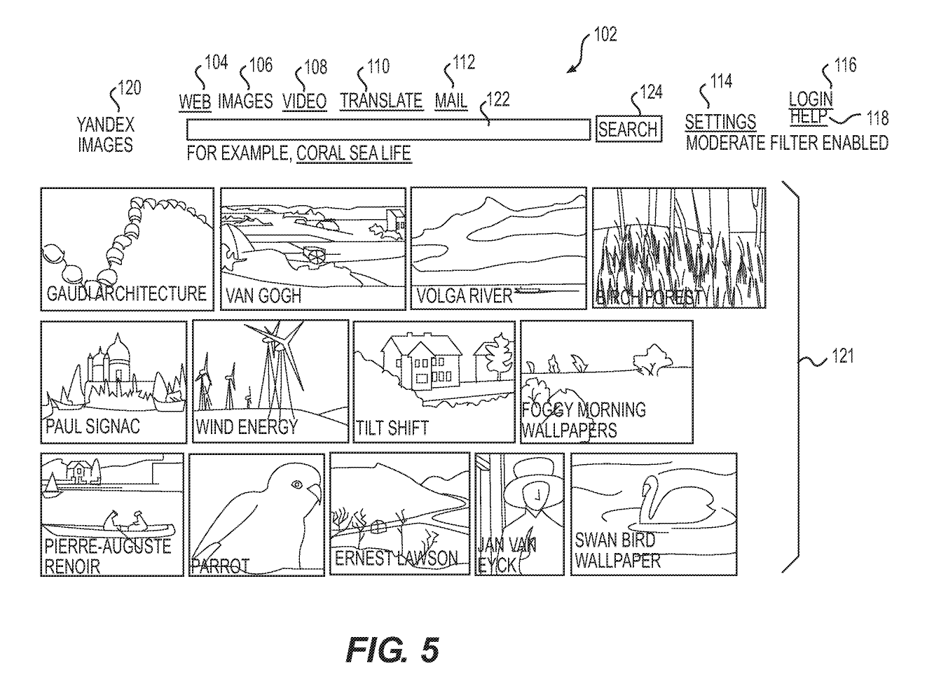

The user 14 first accesses an images search page 102 (FIG. 5) of a search engine via a web browser of the client device 12. It is contemplated that instead of using a web browser, the images search page 102 or a corresponding user interface could be accessed via a dedicated application on the client device 12. FIG. 5 illustrates an images search page 102 of Yandex™. This search page 102 is an exemplary images search page and other layouts of images search page and images search pages from other search engine providers are also contemplated. The search page 102 has links 104, 106 and 108 allowing the user 14 to access a web search page, the images search page 102 and a video search page respectively. There is also a link 110 to a translation page providing translation tools and a link 112 to a mail page allowing the user 14, provided that the user 14 has a corresponding user account, to access his e-mails To the right there is a link 114 to a settings window allowing the user 14 to define some settings for the search engine such as content filters. There is also a link 116 to a login page allowing the user 14 having a corresponding user account to log in his account. There is also a link 118 to a help page to provide assistance to the user 14 on how to user the search engine. The company name and logo 120 to the left of the page 102 provides a link to the web search page. The images search page 102 also displays a number of image thumbnails 121 that when selected by the user 14 each causes an image search in relation to the selected thumbnail 121 to be effected. The images search page 102 also includes a search query entry field 122 and an associated search button 124.

To initiate an image search, the user 14 enters in the search query entry field 122 words corresponding to the type of images he is looking for. This can be done using a physical keyboard, a touchscreen keyboard, or via voice recognition depending on the type of client device 12 being used.

Once the desired words are entered in the field 122, the user 14 confirms his search query by selecting the search button 124 with a mouse or by pressing it on the screen with his finger or by pressing the “enter” key on a keyboard depending on the type of client device being used.

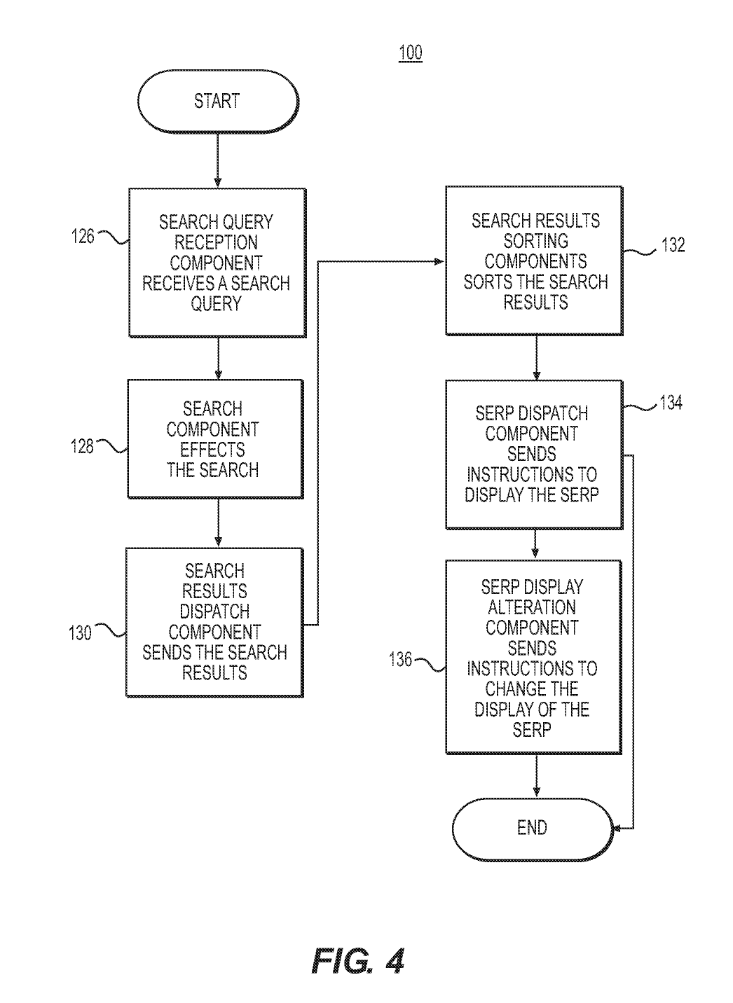

The search query is sent via the internet 16 to the upper level server 20 which initiates the search in respect of the search query. At step 126 of the method 100 (FIG. 4), a search query reception component of the upper level server 20 receives the search query. The search query is then transferred to a search component on the lower level server 24 via the middle level server 22. At step 128, the search components effects a search in respect of the search query of the database of images and associated information described above that is stored on the lower level server 24. The search component retrieves from the database groups of images (i.e. group identification numbers 58) having associated images that are considered relevant to the search query and assigns a relevancy factor to these images. The manner in which the search component determines that an image is relevant to a search query and assigns a relevancy factor corresponds to one of the many manners in which this is achieved in existing image search engines and as such will not be described herein. For example, the search component can determine if a keyword in the metadata associated with an image matches or is synonymous to one or more words of the search query and determines how many times the particular image has been linked to on web pages other than the web page from which it was retrieved. It is contemplated that instead of searching images stored and grouped on a database prior to the image search having been received at step 126, that the search component could at step 128 search for relevant images on web pages hosted on the servers 18 directly and then perform the above described image analysis and image grouping in real time for the retrieved images. Although contemplated, this method would require additional computing power and may result in a greater delay between the time at which the search query is entered by the user 14 and the time when the search results are displayed on the SERP. It is also contemplated that the search could be limited to image groups for web pages that correspond geographically to a geographical location associated with the search engine being used. For example, if a user 14 uses the Yandex™ Russian site to run the search query, the search would be limited to groups containing images retrieved from web pages of Russian websites.

At step 130, a search results dispatch component on the lower level server 24 sends the search results obtained from the search component, by way of a list of relevant group identification numbers 58, to a search results sorting component on the middle level server 22.

At step 132, the search results sorting component sorts the search results. The search results sorting component looks at the number of images associated with each group of images. If a group of images contain only one or two images, the image(s) of this group is (are) dissociated from the group such that this (or these) image(s) will be displayed as individual images on the SERP instead of being displayed as a group. In an alternative embodiment, the images of a group of images are dissociated from the group is the group contains less than four images. The search results sorting component also merges the search results to prevent duplicate images from being displayed on the SERP. This can be done by determining if the same image identification number 56 appears more than once. The search results sorting component then sorts the images according to their relevancy factor. Each image is assigned a rank based on their relevancy factor and images are sorted according to this rank. The higher the rank of an image, the earlier it will appear on the SERP. In the case of groups of images, the group will appear on the SERP at a position corresponding to a rank of the image of the group having the highest rank. The image of a group of images having the highest rank is also identified as a lead image of the group of images. Another search results dispatch component sends the sorted search result to the upper level server 20 which forms the structure and layout of the SERP to be presented to the user 14 on the client device.

At step 134, a search results dispatch component on the upper level server 20 sends the search results to the client device 12 and a SERP dispatch component on the upper level server 20 sends instructions to cause a display of the search results on a SERP to the user 14 via the web browser of the client device 12. The search results and the instructions are sent to the client device 12 via the internet 16. The upper level server 20 also retrieves the thumbnails of the images identified in the search result from the database on the lower level server 24 and sends them to the client device 12 to be displayed on the SERP.

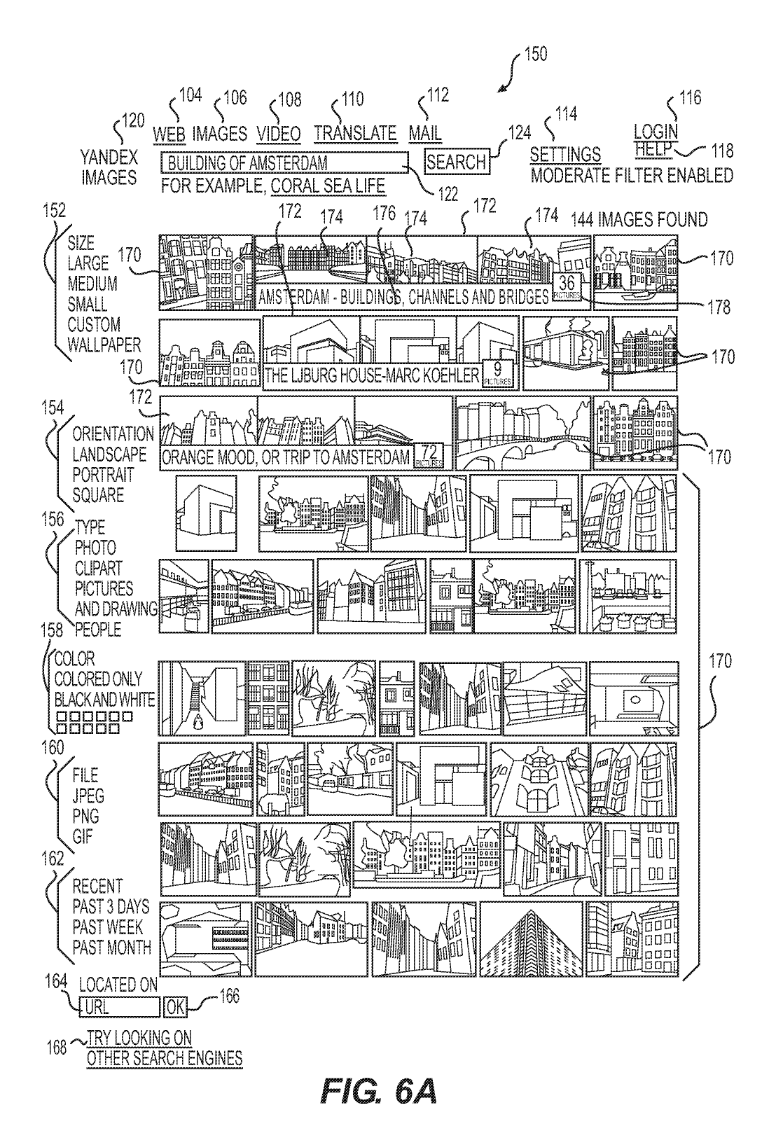

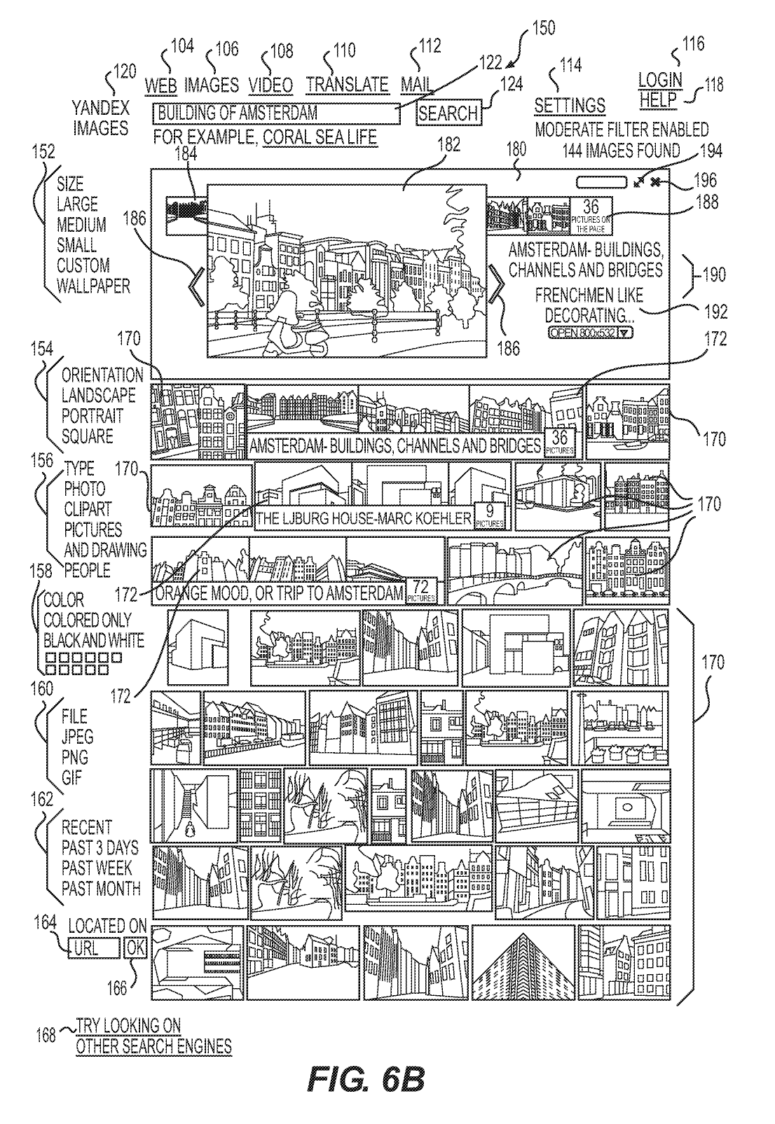

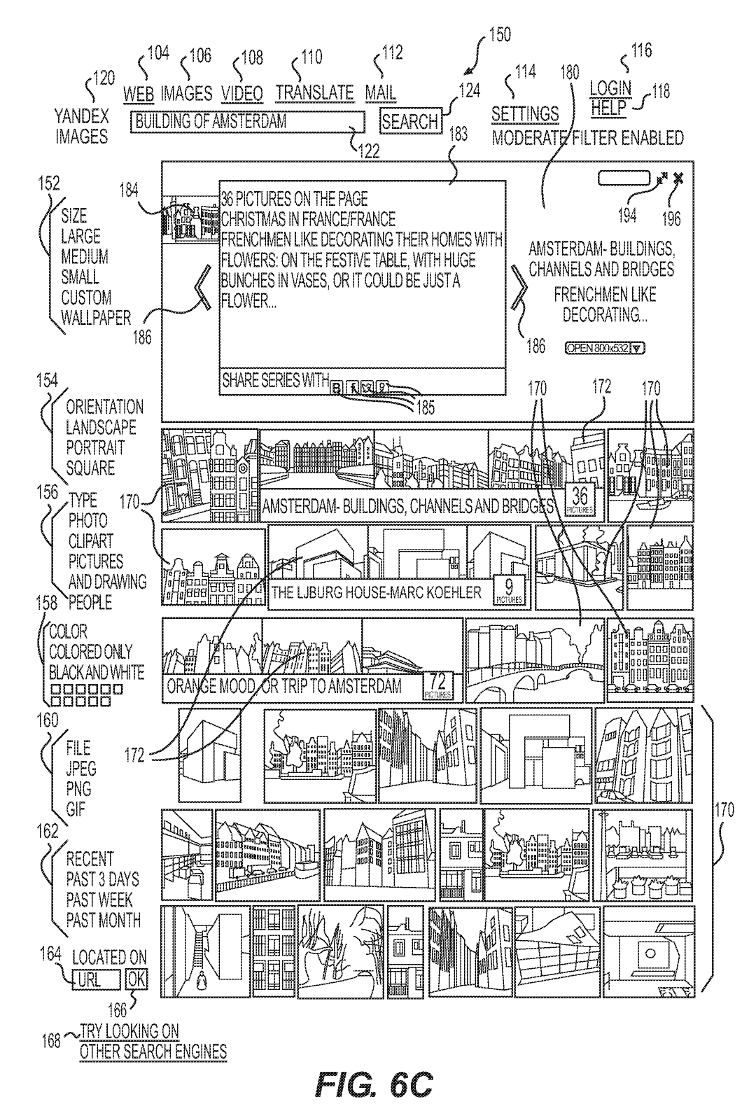

The client device 12 receives via the internet 16 the search results and the instructions to display the SERP to the user 14 on the web browser. FIG. 6A shows an embodiment of a SERP 150. As can be seen in FIG. 6A, the SERP 150 includes some elements of the images search page 102. For simplicity, these elements have been labeled with the same reference numerals and will not be described again. Along a left side of the page, the SERP 150 has various menus allowing the user 14 to refine the search results. The menu 152 allows the selection of only images of a certain size in the search results (i.e. large, medium, small, custom, wallpaper). The menu 154 allows the selection of only images in a certain orientation (i.e. landscape, portrait, square). The menu 156 allows the selection of only images of a certain type (i.e. photos, clipart, pictures and drawings, people). The menu 158 allows the selection of only images of a certain color or color scheme (i.e. color only, black and white, various prevailing colors). The menu 160 allows the selection of only images of a certain file type (i.e. JPEG, PNG, GIF). The menu 162 allows the section of only images within a certain time period (i.e. past three days, past week, past month). A field 164 and button 166 allows the user to specify a specific website from which the images should come from. A link 168 can be used to redirect the user 14 to a SERP of a different search engine showing search results for the same search query.

The SERP 150 also displays the images corresponding to the search results in an array. These include individual images 170 (i.e. images that were dissociated from their group reference numerals) (only some of which have been labelled for clarity) and visual representations of groups of images 172. The individual images 170 and the visual representations of groups of images 172 are arranged in rows, with the most relevant image (an individual image in this case) being in the top left corner of the SERP 150. It is also contemplated that they could be arranged in columns or in some other way. The relevancy of the images decreases toward the right of a row and the lower the row, the less relevant the images it contains are. The individual images 170 are displayed as thumbnails. The visual representations of the groups of images 172 displays three thumbnails 174 side-by-side in a row (only labelled in one visual representation 172 for clarity). The three thumbnails 174 correspond to the three highest ranked images of the corresponding group of images, with the highest ranked image being shown on the left side of the visual representations of the groups of image 172. The SERP 150 does not display all the images that are part of the search results. A button (not shown) at the bottom of the SERP 150 links to a second SERP (not shown) similar to the SERP 150 and showing further images of the search results.

A visual representation of a group of images 172 will be described in more detail below. For clarity, the features of the visual representation of a group of images 172 will only be labelled on one visual representation 172. As mentioned above, the visual representation 172 displays three thumbnails 174 corresponding to the three highest ranked images of the corresponding group of images, with the highest ranked image being shown on the left side of the visual representations of the groups of image 172. It is contemplated that visual representation 172 could display less or more than three thumbnails 174. It is also contemplated that the thumbnails could be arranged in an order other than by rank. For example, the thumbnails 174 could be arranged chronologically based on a time and date of creation of the images corresponding to the thumbnails 174 in order to give at a glance an idea of a chronology of events shown on the thumbnails 174. The thumbnails 174 could also be arranged in some other logical sequence in the visual representation 172.

As can be seen, the visual representation 172 is visually distinguishable on the SERP 150 from the individual images 170 and the other visual representations 172 on the SERP 150. In order to be visually distinguishable, the visual representation 172 has various features. The spacing between the thumbnails 174 is smaller than the spacing between two individual images 170, the spacing between an individual image 170 and a visual representation 172, and the spacing between two visual representations 172. In the SERP 150, the thumbnails 174 are disposed adjacent to each other. The visual representation 172 has a banner 176 spanning the width of the visual representation 172 at a bottom thereof. The banner 176 displays information associated with the images of the group of images associated with the visual representation 172, such as a description of the images and a link to the web page containing the images of the group of images. As would be understood, the group of images likely contains more images than the three thumbnails 174 being shown. For this reason, the visual representation 172 also has a box 178 containing a number corresponding to the number of images present in the group of images.

Should the user 14 not select a thumbnail 170 or a visual representation 172, the method 100 ends or starts over should the user 14 enter a new search query. When the user 14 selects a thumbnail 170 or a visual representation 172 on the SERP 150 by clicking on it for example, an indication of this selection is sent via the internet 16 to the upper level server 20. At step 136, a SERP display alteration component on the upper level server 20 sends instructions via the internet 16 to the client device 12 to change the display of the SERP 150. The client device 12 receives these instructions and changes the display of the SERP 150 without leaving the SERP 150. If the user selects a thumbnail 170 of an individual image, the display is modified to display a larger or full size version of the image corresponding to the selected thumbnail and information associated with the image, such as, for example, an excerpt of the web page containing the image, the name of the image and a link to the web page containing the image. If the user selects a visual representation 172, the display of the SERP 150 is modified to display a larger second visual representation of the group of images 180 of the selected visual representation 172 as can be seen in FIG. 6B. The second visual representation 180 is displayed above the row containing the selected visual representation 172. The second visual representation 180 contains one large (or full size) image 182 and thumbnails 184 of other images of the group of image. Arrows 186 allow the user 14 to browse the images of the group of image by causing the thumbnail 184 to the left or right of the image 182, depending on the arrow 186 that the user 14 clicks, to now being displayed as the large image 182, and the thumbnails 184 are modified accordingly. The second visual representation 180 also has an indication 188 of the number of images in the group of images, information regarding the group of images 190 such as, for example, an excerpt of the web page containing the images, the name of the images and a link 192 to the web page containing the images. The second visual representation 180 also has an icon 194 which, when selected by the user 14, expands the second visual representation 180 further, and an icon 196 to close the second visual representation 180. FIG. 6C illustrates a final slide 183 of the visual representation 180. The final slide 183 provides additional information about the group of images of the selected visual representation of the group of images 172. This additional information includes the number of images on the corresponding web page, the title of the associated article and a portion of the text of the article that is relevant to the group of images. The final slide 183 has icons 185 that when selected permit sharing of the group of images and/or its associated information (i.e. one or more of a hyperlink to the web page, title of the article, details of the search query . . . ) via various service such as Facebook™, VKontakte™, and Twitter™. The final slide 183 also serves as an indicator to the user that the end of the group of images has been reached. If the user 14 selects another individual thumbnail 170 or another visual representation 172, the second visual representation 180 is closed and the above steps are repeated for the newly selected image 170 or visual representation 172.

It is contemplated that instead of modifying the display of the SERP 150 as described above when the user 14 selects an individual thumbnail 170 or a visual representation 172, that the client device 12 could open the web page containing the image(s) associated with the selected thumbnail 170 or visual representation 172. The web page could replace the SERP 150 or be opened in a different window or in a different tab of the browser.

It is contemplated that the components described above with respect to the method 100 could be provided on one of the servers 20, 22, 24 other than the one being described and that their functions could be split onto more than one of the servers 20, 22, 24.

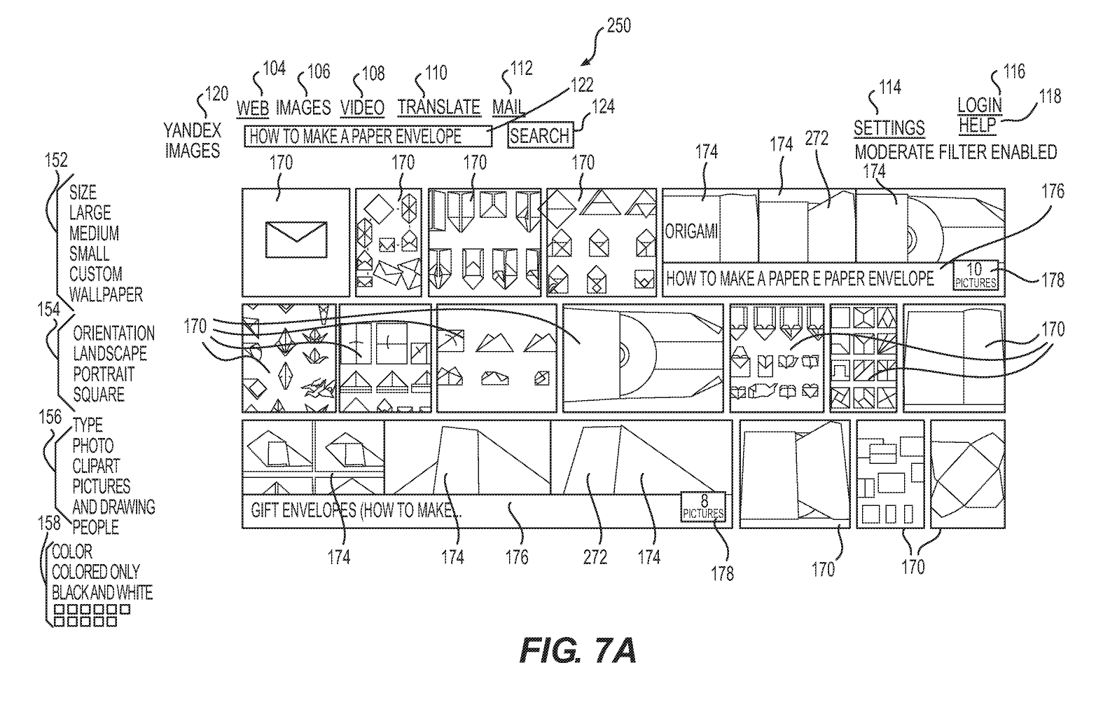

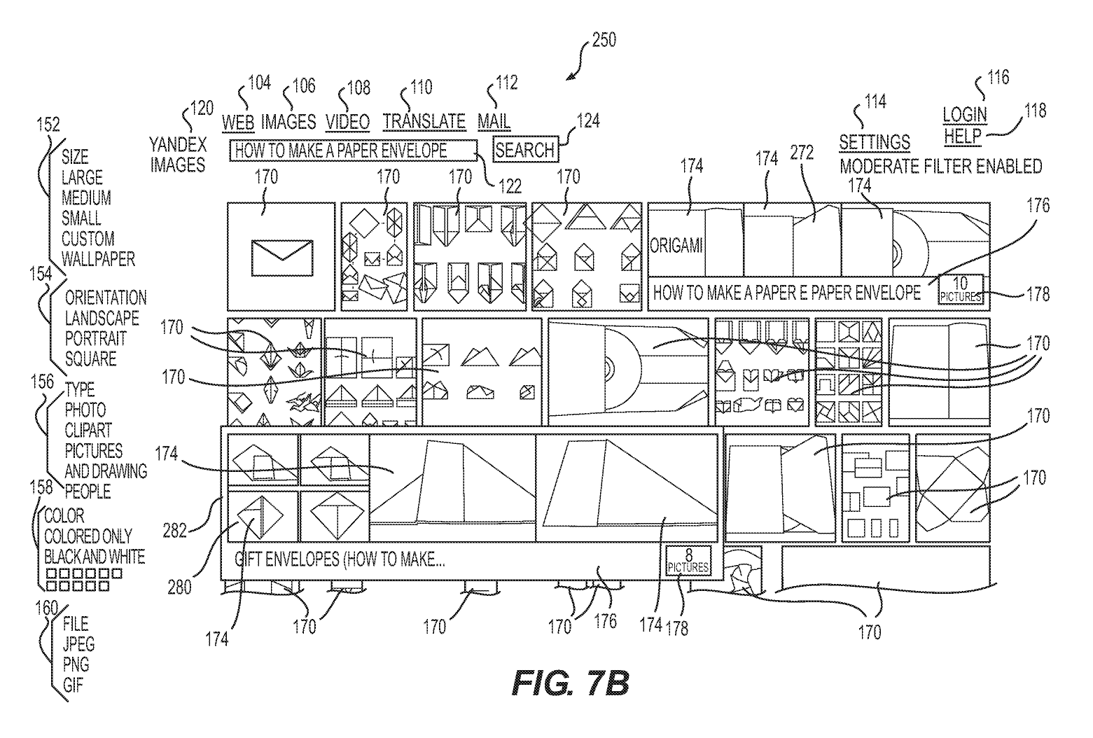

Turning now to FIGS. 7A to 15, alternative embodiments of the SERP 150 will be described. For simplicity, elements of the alternative embodiments of the SERP 150 described below that are similar to those of the SERP 150 have been labelled with the same reference numerals and will not be described again in detail herein.

FIG. 7A shows a SERP 250. In the SERP 250, the visual representations of the groups of images 272 have the same features as the visual representations 172 described above. However, when the user 14 selects a visual representation 272, the SERP display alteration component on the upper level server 20 sends instructions via the internet 16 to the client device 12 to change the display of the SERP 250 to display an expanded version 280 of the visual representation 272. As can be seen in FIG. 7B, the expanded version 280 displays the thumbnails 174 over a box 282 having a color that is different from a color surrounding the other thumbnails 170 and visual representations 272. The banner 176 and the box 178 are no longer displayed over the thumbnails 174 and the information that was in the banner 176 now appears in the box 282 under the thumbnails 174. The box 178 is also in the box 282 under the thumbnails 174. The box 282 overlaps the thumbnails 170 in the row of thumbnails 170 under the row in which the visual representation 272 that was selected is located.

It is contemplated that the SERP 150 described above could display the visual representation 280 when the user “mouse-overs” the visual representation 172 and the visual representation 180 when the user “clicks” or otherwise selects the visual representation 172.

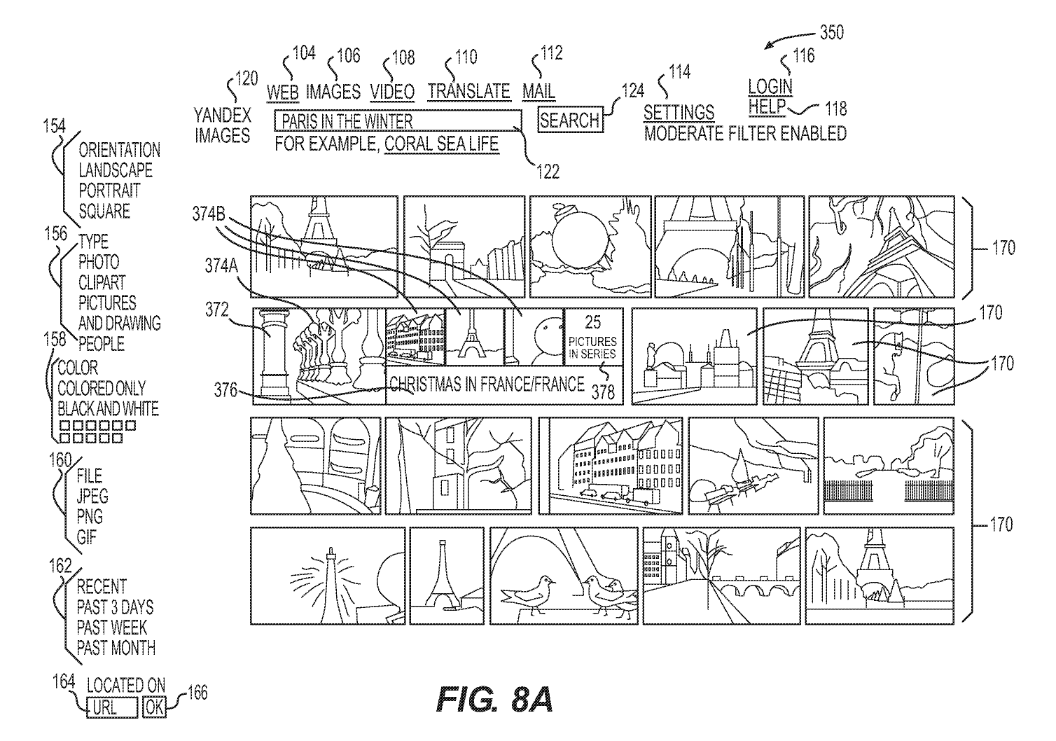

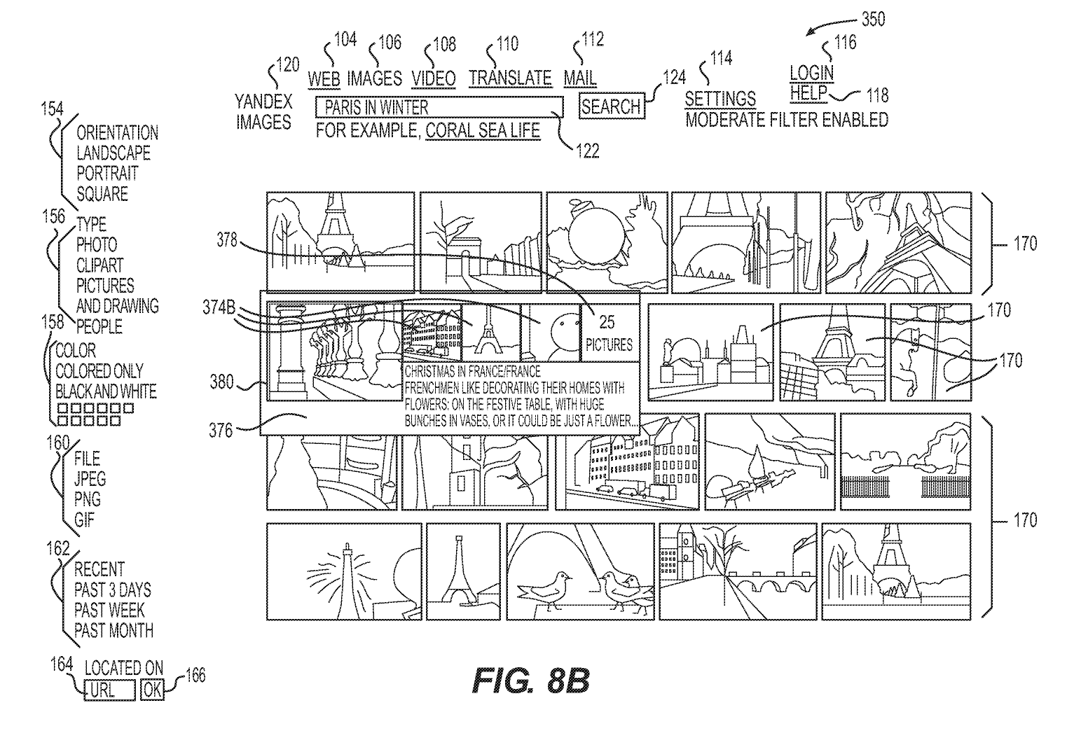

FIG. 8A shows a SERP 350. In the SERP 350, the visual representations of the groups of images 372 includes a thumbnail 374A of the highest ranked image of the group of images and three smaller thumbnails 374B of the next highest ranked images. To the right of the thumbnails 374B, a box 378 provides an indication of the number of images in the group of images. The box 378 has a size similar to that of the thumbnails 374B. A banner 376 disposed below the thumbnails 374B and the box 378 and to the right of the thumbnail 374A provides information similar to that of the banner 176 described above. The color around the thumbnails 374A, 374B, the banner 376 and the box 378 differs from the color around the individual thumbnails 170. When the user 14 selects a visual representation 372, the display of the SERP 350 is modified to show an expanded version 380 of the visual representation 372 as shown in FIG. 8B in a manner similar to the expanded version 280 described above.

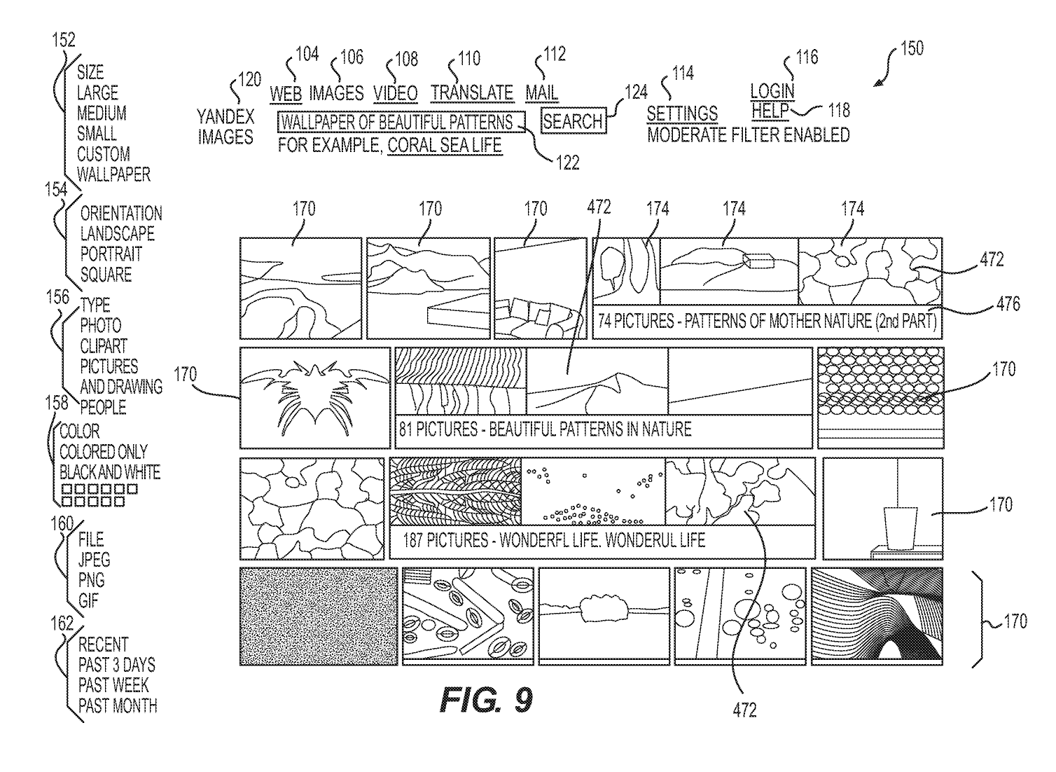

FIG. 9 shows a SERP 450. In the SERP 450, the visual representations of the groups of images 472 do not include a box similar to the box 178 to indicate the number of images in the group of images. Instead, the number of images in the group of images is the first information to appear in the banner 476 which also displays information similar to the information in the banner 176.

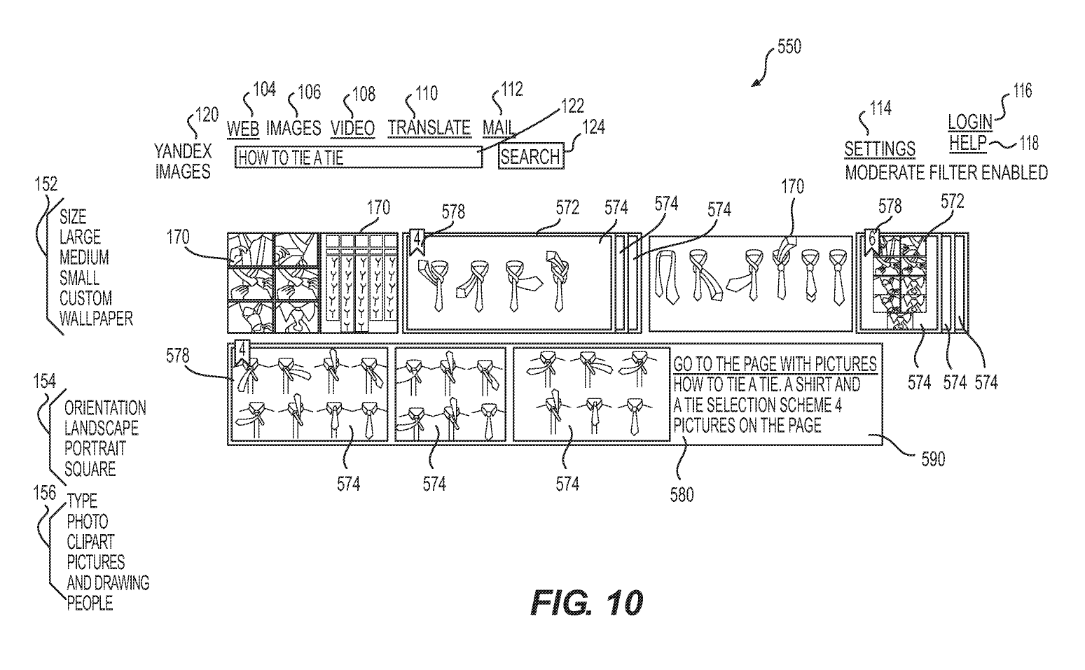

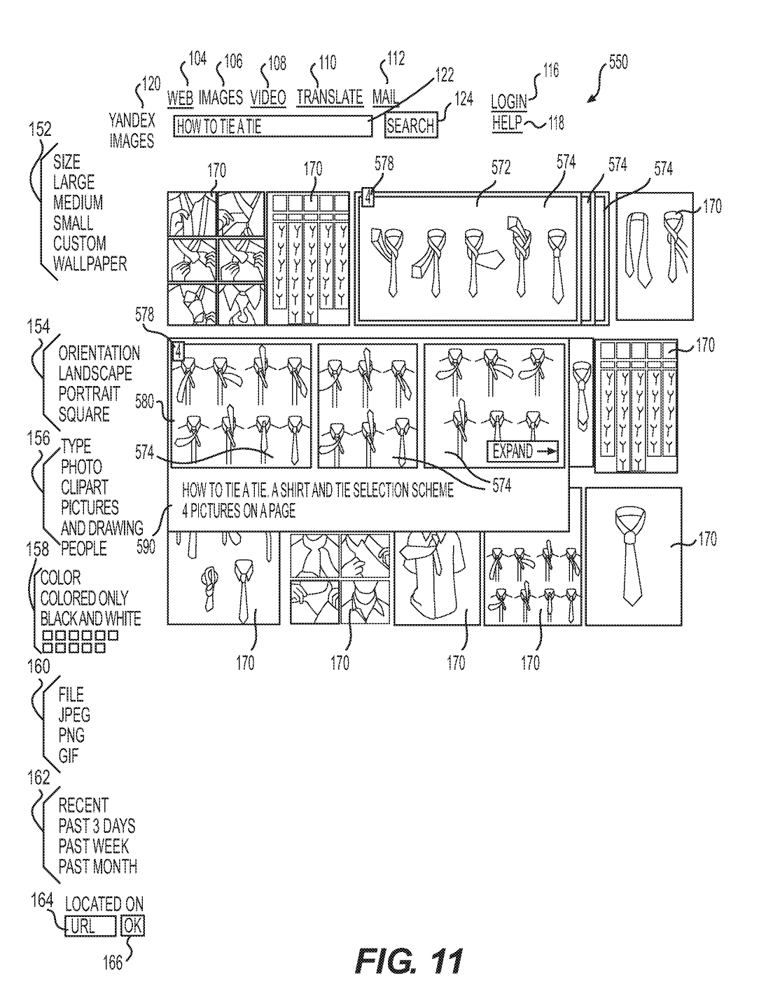

FIG. 10 shows a SERP 550. In the SERP 550, the visual representations of the groups of images 572 include three thumbnails 574 arranged in a stack. The thumbnail 574 of the highest ranked image is completely shown. The thumbnail 574 of the next highest ranked image is disposed behind the first thumbnail 574 so as to be partially hidden thereby. The thumbnail 574 of the next highest ranked image is disposed behind the first and second thumbnails 574 so as to be partially hidden thereby. The color around the thumbnails 574 differs from the color around the individual thumbnails 170. A ribbon 578 provides an indication of the number of images in the group of images. When the user 14 selects a visual representation 572, the display of the SERP 550 is modified to show an expanded version 580 of the visual representation 572 which overlaps some of the thumbnails 170 that surrounded the selected visual representation 572. In the expanded version 580, the three thumbnails 574 are shown side-by-side in a row and information 590 regarding the images is displayed to the right of the thumbnails 574. In an alternative embodiment shown in FIG. 11, the information 590 is displayed below the thumbnails 574 in the expanded version 580.

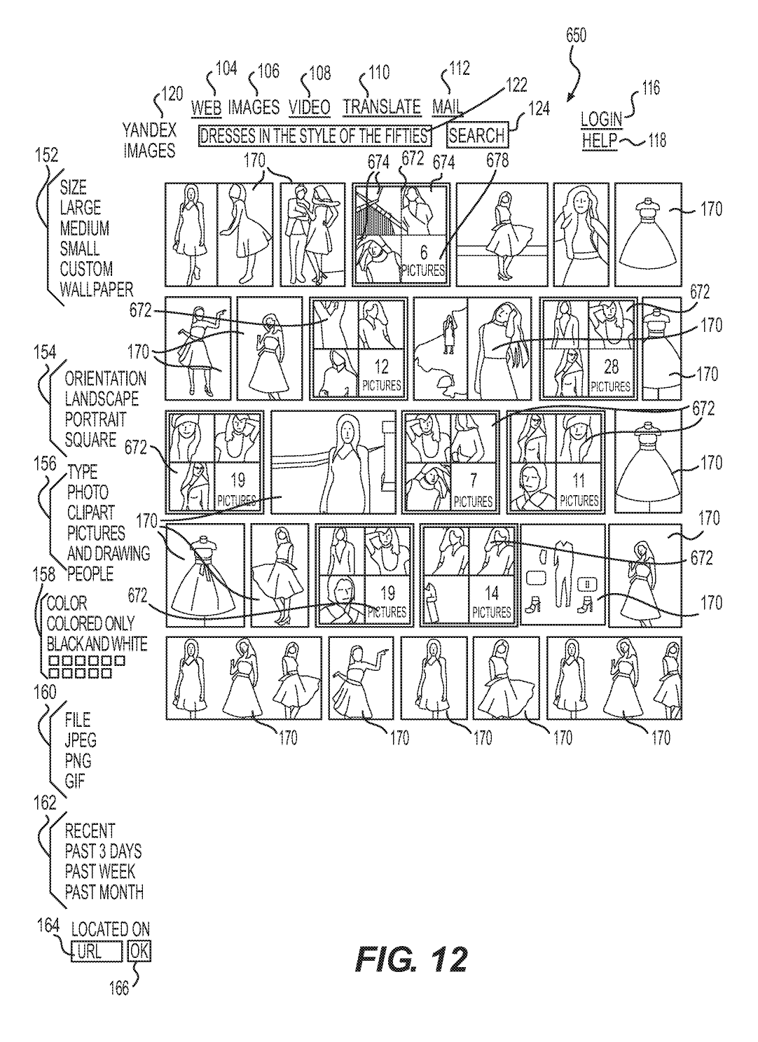

FIG. 12 shows a SERP 650. In the SERP 650, the visual representations of the groups of images 672 include three thumbnails 674 (only labelled in one visual representation 672 for clarity) arranged in a tiled array with a box 678 (only labelled in one visual representation 672 for clarity) providing an indication of the number of images in the group of images.

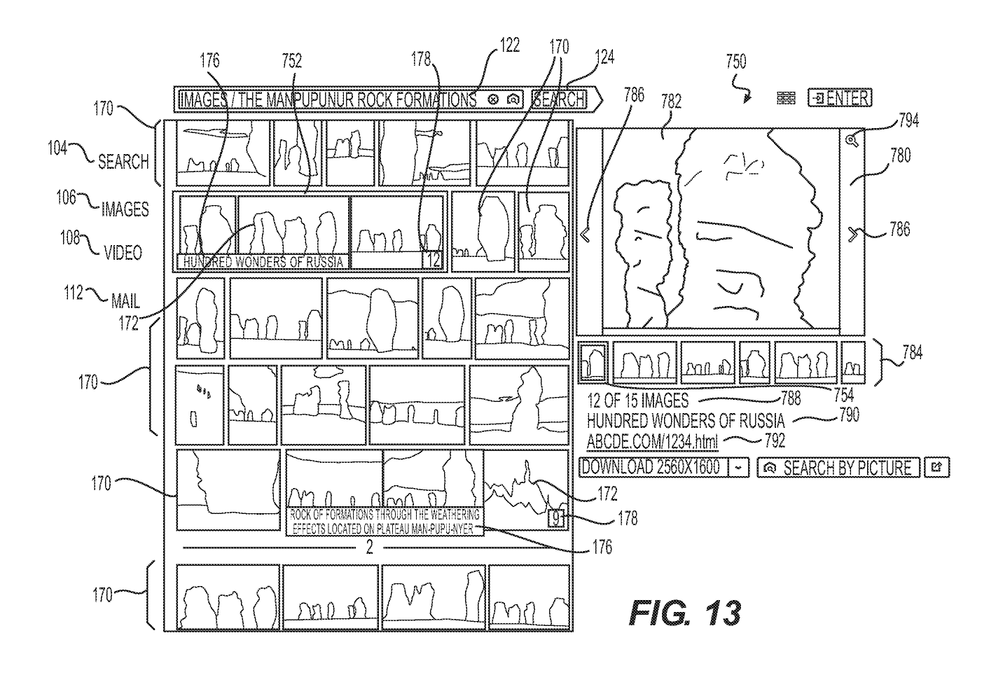

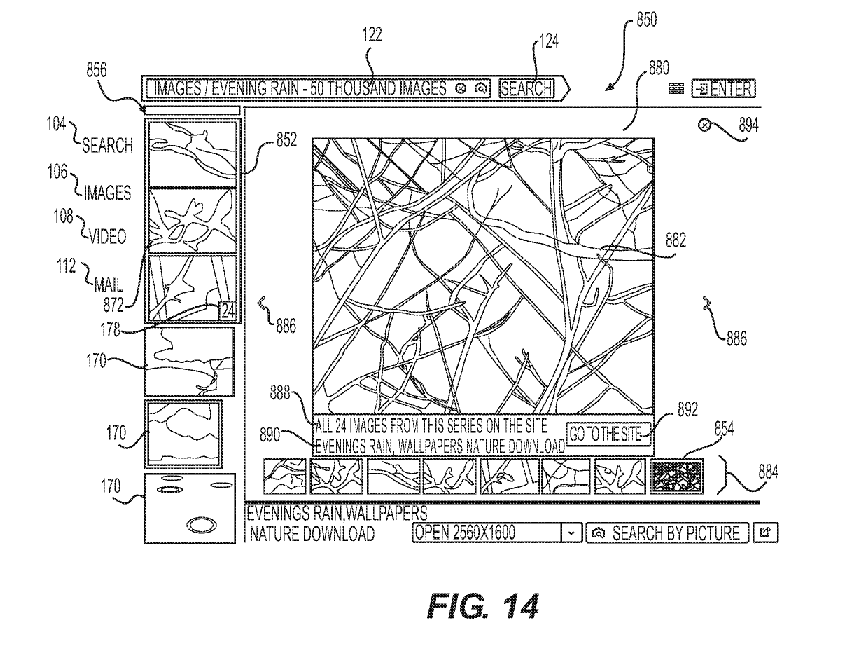

FIG. 13 shows a SERP 750. In one embodiment, if the user 14 selects a visual representation 172 or an individual image 170 in a SERP similar to the one shown in FIG. 6A, the display of this SERP is modified to be displayed like the SERP 750 shown in FIG. 13. If a visual representation 172 is selected by the user 14, the SERP 750 displays a larger second visual representation of the group of images 780 of the selected visual representation 172. The second visual representation 780 is displayed to the right of the individual images 170 and the visual representations 172. It is contemplated that the second visual representation 780 could be displayed to the left of the individual images 170 and the visual representations 172. The selected visual representation 172 has a colored border 752 around it. The second visual representation 780 contains one large image 782 and thumbnails 784 of the images of the group of images displayed in a row below the large image 782. Upon selection of the visual representation 172, the large image 782 corresponds to the most relevant image of the group of images. Arrows 786 allow the user 14 to browse the images of the group of images by causing the next or previous thumbnail 784 in the row below the large image 782, depending on the arrow 786 that the user 14 clicks, to now be displayed as the large image 782. It should be noted that the left arrow 786 is shown in dotted lines in FIG. 13 because the image 782 corresponds to the most relevant image of the group of images, as such the user 14 cannot select a previous thumbnail 784 in the row below the large image 782, and therefore in this situation the left arrow 786 is not displayed. Similarly, when the large image 782 being displayed corresponds to the last thumbnail 784 in the row below the large image 782, the right arrow 786 is not displayed. The user 14 can also view as the large image 782 another image of the group of images by selecting one of the thumbnails 784. The thumbnail 784 corresponding to the large image 782 has a colored border 754 around it. The second visual representation 780 also has an indication 788 of the number of images in the group of images, information regarding the group of images 790 such as, for example, an excerpt of the web page containing the images, the name of the images and a link 792 to the web page containing the images. The second visual representation 780 also has an icon 794 which, when selected by the user 14, expands the second visual representation 780 further, as will be described in greater detail below with respect to FIG. 14. It is contemplated that the second visual representation 780 could be also be expanded further by selecting the large image 782. When the user 14 selects an individual image 170, this image is displayed as the large image 782 in the second visual representation 780, but elements pertaining to group of images are not displayed such as the thumbnails 784 and the indication 788 of the number of images in the group of images.

It is contemplated that in the SERP 750 should the user 14 move a selection cursor over a visual representation 172 (i.e. mouse over) but not select it (i.e. not click it), that the visual representation 172 could expand to display additional information regarding the group of images below the images in the visual representation 172.

It is also contemplated that instead of the SERP 750 being a modified version of a SERP similar to the SERP 150 once a visual representation 172 or an individual image 170 is selected, that the SERP 750 could be the initial SERP being displayed following the search query by the user 14. In such an embodiment, following the search query, the most relevant image is displayed as the large image 782, and if this image belongs to a group of images, the thumbnails 784 and the elements of the second visual representation 780 associated with groups of images are also displayed. When the user 14 selects an image 170 or a visual representation 172, the second visual representation 780 is modified accordingly. Alternatively, it is contemplated that instead of initially displaying the most relevant image, the second visual representation 780 could be left blank until the user 14 selects an individual image 170 or a visual representation 172. Selecting another individual image 170 or visual representation 172 modifies the second visual representation 780 accordingly.

FIG. 14 shows a SERP 850. In one embodiment, if the user 14 selects the icon 794 or the large image 782 in a SERP similar to the one shown in FIG. 13, the display of this SERP is modified to be displayed like the SERP 850 shown in FIG. 13. In the SERP 850, the second visual representation 780 is expanded further as a third visual representation 880 and the individual images 170 and the visual representation 172 are reorganized to be displayed in a single column 856 to the left of the third visual representation 880. It is contemplated that the column 856 could be to the right of the visual representation 880. To permit the display in the column 856, the three thumbnails that are displayed horizontally next to each other in the visual representations 172 are rearranged to be vertically next to each other in visual representations 872. The more relevant an individual image 170 and or a visual representation 872 is, the closer to the top of the column 856 it is. If the large image 782 was part of a visual representation 172, the corresponding visual representation 872 has a colored border 852 around it. The third visual representation 880 contains a larger version of the image 782 and thumbnails 884 of the images of the group of images displayed in a row below the larger image 882. Arrows 886 allow the user 14 to browse the images of the group of images by causing the next or previous thumbnail 884 in the row below the large image 882, depending on the arrow 886 that the user 14 clicks, to now be displayed as the larger image 882. The user 14 can also view as the larger image 882 another image of the group of images by selecting one of the thumbnails 884. The thumbnail 884 corresponding to the larger image 882 has a colored border 854 around it. The third visual representation 880 also has an indication 888 of the number of images in the group of images, information regarding the group of images 890 such as, for example, an excerpt of the web page containing the images, the name of the images and a button 892 linking to the web page containing the images. The third visual representation 880 also has an icon 894 which, when selected by the user 14, modifies the SERP 850 to be displayed back to a SERP similar to the one shown in FIG. 13. When the image 782 was an individual image 170, this image is displayed as the large image 882 in the third visual representation 880, but elements pertaining to group of images are not displayed such as the thumbnails 884 and the indication 888 of the number of images in the group of images. Selecting another individual image 170 or visual representation 872 from the column 856 modifies the third visual representation 880 accordingly.

It is also contemplated that instead of the SERP 850 being a modified version of a SERP similar to the SERP 750 once the icon 794 or the large image 782 is selected, that the SERP 850 could be the initial SERP being displayed following the search query by the user 14. In such an embodiment, following the search query, the most relevant image is displayed as the large image 882, and if this image belongs to a group of images, the thumbnails 884 and the elements of the third visual representation 880 associated with groups of images are also displayed. When the user 14 selects an image 170 or a visual representation 872, the third visual representation 880 is modified accordingly. Alternatively, it is contemplated that instead of initially displaying the most relevant image, the third visual representation 880 could be left blank until the user 14 selects an individual image 170 or a visual representation 872.

It is also contemplated that instead of the SERP 850 being a modified version of a SERP similar to the SERP 750 once the icon 794 or the large image 782 is selected, if the user 14 selects a visual representation 172 or an individual image 170 in a SERP similar to the one shown in FIG. 6A, the display of this SERP could modified to be displayed like the SERP 850 shown in FIG. 14.

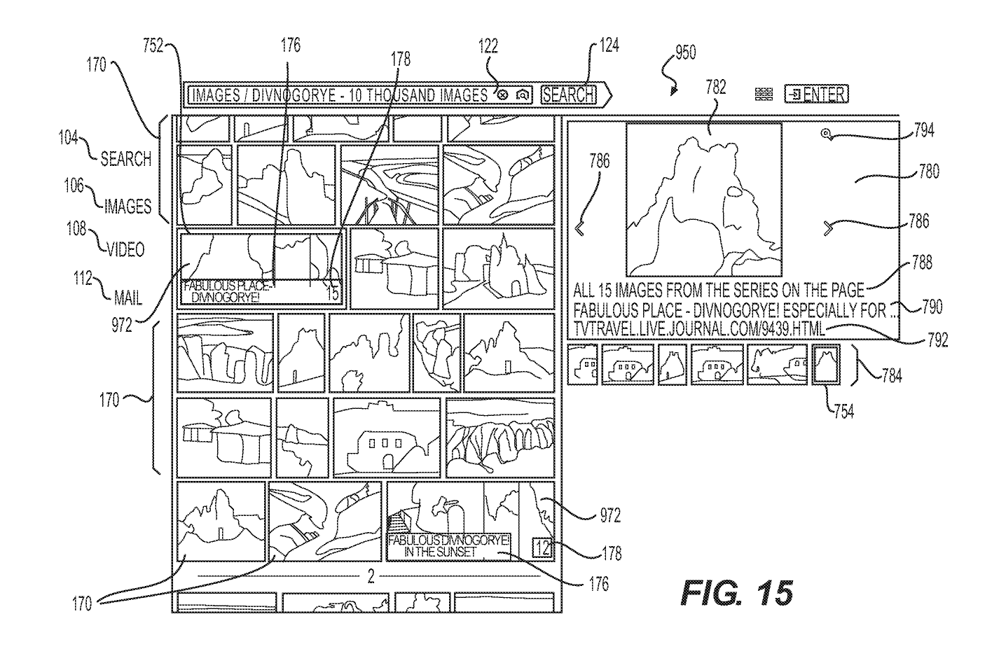

FIG. 15 shows a SERP 950 that is an alternative embodiment of the SERP 750 of FIG. 13. In the SERP 950, the group of images are displayed as visual representations 972 where the thumbnails of the most relevant images of the group are arrange in a stack in a manner similar to that of the SERP 550 of FIG. 10. In the SERP 950, the elements 788, 790 and 792 are disposed between the image 782 and the thumbnails 784. The other aspects of the SERP 950 are similar to those of the

SERP 750. For simplicity, these aspects will not be described again and similar elements have been labelled with the same reference numbers as in the SERP 750.

Modifications and improvements to the above-described embodiments of the present invention may become apparent to those skilled in the art. The foregoing description is intended to be exemplary rather than limiting. The scope of the present invention is therefore intended to be limited solely by the scope of the appended claims.

1. A method for providing image information for display to a user of a client device comprising:
receiving, by at least one server from the client device via a communications network, a search query;
effecting, by the at least one server, a search in respect of the search query;
sending, by the at least one server to the client device via the communications network, search results in respect of the search query, the search results including a group of images and at least one other image, the group of images being selected from a plurality of groups of images stored on the at least one server prior to having received the search query;
sending, by the at least one server to the client device, instructions to cause a display to the user via a user interface of the client device of a search engine results page (SERP) including the at least one other image and a visual representation of the group of images, the visual representation of the group of images and the at least one other image being displayed in an array,
the visual representation of the group of images being visually distinguishable on the user interface of the client device from the at least one other image,
the visual representation of the group of images including at least one image of the group of images.

2. The method of claim 1, wherein each of the plurality of groups of images stored on the at least one server includes a plurality of similar images selected from images stored on the at least one server prior to having received the search query.

3. The method of claim 2, wherein the images stored on the at least one server have been retrieved from internet resources.

4. The method of claim 2, wherein the at least one other image is selected from the images stored on the at least server prior to having received the search query.

5. The method of claim 2, wherein each image of the images stored on the at least one server prior to having received the 2 query has an image identification number; and
wherein identical images have a common image identification number.

6. The method of claim 5, wherein each of the plurality of groups of images has a group identification number; and
wherein each group identification number has a plurality of corresponding image identification numbers.

7. The method of claim 2, wherein the images stored on the at least one server are stored as thumbnails.

8. The method of claim 2, wherein the images stored on the at least one server are stored with metadata associated with the images.

9. The method of claim 1, wherein the at least one image of the group of images is displayed as a thumbnail.

10. The method of claim 1, wherein the group of images is a plurality of groups of images, the visual representation of each of the plurality of groups of images being visually distinguishable on the user interface of the client device from the visual representation of a remainder of the plurality of groups of images.

11. The method of any one of claims 1 to 10, wherein the at least one other image is at least one individual image.

12. The method of claim 11, wherein the at least one individual image is displayed as a thumbnail in the array on the user interface of the client device.

13. The method of claim 11, wherein a color of the visual representation of the group of images around the at least one image of the group of images differs from a color around the at least one individual image on the SERP.

14. The method of claim 11, wherein:
the at least one image of the group of images is at least two images of the group of images;
the at least one individual image is at least two individual images; and
a spacing between the at least two images of the group of images differs from a spacing between the at least two individual images.

15. The method of claim 1, wherein the at least one other image is at least one other group of images selected from the plurality of groups of images stored on the at least one server prior to having received the search query, the at least one other group of images having a visual representation being visually distinguishable on the user interface of the client device from the visual representation of the group of images.

16. The method of claim 1, wherein the images of the group of images are visually similar.

17. The method of claim 16, wherein the images of the group of images have a similar color histogram.

18. The method of claim 16 or 17, wherein the images of the group of images have a similar histogram of gradient.

19. The method of claim 18, wherein the images of the group of images have similar prevailing colors.

20. The method of claim 16 or 17, wherein the images of the group of images have similar prevailing colors.

21. The method of claim 16, wherein the images of the group of images are of similar size and proportion.

22. The method of claim 1, wherein images of the group of images are from a single web page.

23. The method of claim 22, wherein the visual representation of the group of images includes a hyperlink to the single web page.

24. The method of claim 22, wherein the single web page has a geographical correspondence to a geographical location associated with the user interface of the client device.

25. The method of claims 1 to 9, wherein the visual representation of the group of images displays less images than a number of images present in the group of images.

26. The method of claim 25, wherein the visual representation of the group of images includes an indication of the number of images present in the group of images.

27. The method of claim 1, wherein the group of images includes at least four images.

28. The method of claim 1, wherein the visual representation of the group of images includes a banner displaying information associated with the images of the group of images.

29. The method of claim 9, wherein the at least one image of the group of images is at least two images of the group of images displayed as thumbnails.

30. The method of claim 29, wherein the at least two images are disposed side-by-side in a row.

31. The method of claim 29, wherein the at least two images of the group of images is at least three images of the group of images disposed in a tiled array.

32. The method of claim 29, wherein one of the at least two images is completely shown and other images of the at least two images are partially hidden by at least one of:
the one of the at least two images, and
another of the other images of the at least two images.

33. The method of claim 29, wherein the at least two images are arranged in a logical sequence in the visual representation.

34. The method of claim 1, wherein the images of the group of images are ranked; and
wherein the at least one image of the group of images of the visual representation of the group of images includes an image of the group of images having a highest rank.

35. The method of claim 1, wherein sending, by the at least one server to the client device via the communications network, the search results in respect of the search query includes:
sending, by the at least one server to the client device via the communications network, the search results in respect of the search query sorted by relevancy factor.

36. The method of claim 1, further comprising sending, by the at least one server to the client device via the communications network, instructions to cause a change in the display of the visual representation of the group of images via the user interface of the client device to include a display of an expanded version of the group of images having been selected by the user, without leaving the SERP.

37. The method of claim 36, wherein the expanded version of the visual representation of the group of images includes at least one of the images of the group of images in full.

38. The method of claim 36, wherein the expanded version of the visual representation of the group of images at least partially overlaps at least one of the at least one other image.

39. The method of claim 1, wherein the visual representation of the group of images is a first visual representation of the group of images; and
further comprising, upon receiving by the at least one server via the communications network an indication of selection of the group of images by the user on the user interface of the client device, sending, by the at least one server to the client device via the communications network, instructions to cause a display to the user via the user interface of the client device a second visual representation of the group of images without leaving the SERP,
the second visual representation of the group of images being larger in size than the first visual representation of the group of images.

40. The method of claim 1, wherein the search results are based at least in part on metadata and image data associated with images searched by the at least one server.

41. The method of claim 1, wherein the at least one other image is at least one first other image; and
wherein the search results further include at least one second other image, the at least one second other image not being displayed on the SERP.

42. A method of presenting image information to a user of a client device comprising:
receiving, from the user via a user interface of the client device, a search query;
sending, from the client device to at least one server via a communications network, the search query;
receiving, from the at least one server by the client device via the communications network, search results in respect of the search query, the search results including a group of images and at least one other image, the group of images being selected from a plurality of groups of images stored on the at least one server prior to having received the search query;
displaying, to the user via the user interface of the client device, a search engine results page (SERP) including the at least one other image and a visual representation of the group of images,
the visual representation of the group of images and the at least one other image being displayed in an array,
the visual representation of the group of images being visually distinguishable on the user interface of the client device from the at least one other image,
the visual representation of the group of images including at least one image of the group of images.

43. The method of claim 42, wherein each of the plurality of groups of images stored on the at least one server includes a plurality of similar images selected from images stored on the at least one server prior to having received the search query.

44. The method of claim 43, wherein the images stored on the at least one server have been retrieved from internet resources.

45. The method of claim 43, wherein the at least one other image is selected from the images stored on the at least server prior to having received the search query.

46. The method of claim 43, wherein each image of the images stored on the at least one server prior to having received the search query has an image identification number; and
wherein identical images have a common image identification number.

47. The method of claim 46, wherein each of the plurality of groups of images has a group identification number; and
wherein each group identification number has a plurality of corresponding image identification numbers.

48. The method of claim 43, wherein the images stored on the at least one server are stored as thumbnails.

49. The method of claim 43, wherein the images stored on the at least one server are stored with metadata associated with the images.

50. The method of claim 42, wherein the at least one image of the group of images is displayed as a thumbnail.

51. The method of claim 42, wherein the group of images is a plurality of groups of images, the visual representation of each of the plurality of groups of images being visually distinguishable on the user interface of the client device from the visual representation of a remainder of the plurality of groups of images.

52. The method of any one of claims 42 to 51, wherein the at least one other image is at least one individual image.

53. The method of claim 52, wherein the at least one individual image is displayed as a thumbnail in the array on the user interface of the client device.

54. The method of claim 52, wherein a color of the visual representation of the group of images around the at least one image of the group of images differs from a color around the at least one individual image on the SERP.

55. The method of claim 52, wherein:
the at least one image of the group of images is at least two images of the group of images;
the at least one individual image is at least two individual images; and
a spacing between the at least two images of the group of images differs from a spacing between the at least two individual images.

56. The method of claim 42, wherein the at least one other image is at least one other group of images selected from the plurality of groups of images stored on the at least one server prior to having received the search query, the at least one other group of images having a visual representation being visually distinguishable on the user interface of the client device from the visual representation of the group of images.

57. The method of claim 42, wherein the images of the group of images are visually similar.

58. The method of claim 57, wherein the images of the group of images have a similar color histogram.

59. The method of claim 57 or 58, wherein the images of the group of images have a similar histogram of gradient.

60. The method of claim 59, wherein the images of the group of images have similar prevailing colors.

61. The method of claim 57 or 58, wherein the images of the group of images have similar prevailing colors.

62. The method of claim 57, wherein the images of the group of images are of similar size and proportion.

63. The method of claim 42, wherein images of the group of images are from a single web page.

64. The method of claim 63, wherein the visual representation of the group of images includes a hyperlink to the single web page.

65. The method of claim 63, wherein the single web page has a geographical correspondence to a geographical location associated with the user interface of the client device.

66. The method of claims 42 to 50, wherein the visual representation of the group of images displays less images than a number of images present in the group of images.

67. The method of claim 66, wherein the visual representation of the group of images includes an indication of the number of images present in the group of images.

68. The method of claim 42, wherein the group of images includes at least four images.

69. The method of claim 42, wherein the visual representation of the group of images includes a banner displaying information associated with the images of the group of images.

70. The method of claim 50, wherein the at least one image of the group of images is at least two images of the group of images displayed as thumbnails.

71. The method of claim 70, wherein the at least two images are disposed side-by-side in a row.

72. The method of claim 70, wherein the at least two images of the group of images is at least three images of the group of images disposed in a tiled array.

73. The method of claim 70, wherein one of the at least two images is completely shown and other images of the at least two images are partially hidden by at least one of:
the one of the at least two images, and
another of the other images of the at least two images.

74. The method of claim 70, wherein the at least two images are arranged in a logical sequence in the visual representation.

75. The method of claim 42, wherein the images of the group of images are ranked; and
wherein the at least one image of the group of images of the visual representation of the group of images includes an image of the group of images having a highest rank.

76. The method of claim 42, wherein receiving, from the at least one server by the client device via the communications network, the search results in respect of the search query includes:
receiving, from the at least one server by the client device via the communications network, the search results in respect of the search query sorted by relevancy factor.

77. The method of claim 42, further comprising, upon receiving an indication of selection from the user of the group of images, expanding the visual representation of the group of images without leaving the SERP.

78. The method of claim 77, wherein expanding the visual representation of the group of images includes expanding the visual representation of the group of images to display in full at least one of the images of the group of images.

79. The method of claim 77, wherein expanding the visual representation of the group of images includes expanding the visual representation of the group of images to at least partially overlap at least one of the at least one other image.

80. The method of claim 42, wherein the visual representation of the group of images is a first visual representation of the group of images; and
further comprising, upon receiving an indication of selection from the user of the group of images, displaying a second visual representation of the group of images without leaving the SERP,
the second visual representation of the group of images being larger in size than the first visual representation of the group of images.

81. The method of claim 42, wherein the search results are based at least in part on metadata and image data associated with images searched by the at least one server.

82. The method of claim 42, wherein the at least one other image is at least one first other image; and
wherein the search results further include at least one second other image, the at least one second other image not being displayed on the SERP.

83. A system for providing image information for display to a user of a client device comprising:
a search query reception component for receiving, by at least one server from the client device via a communications network, a search query;
a search component for effecting, by the at least one server, a search in respect of the search query;
a search results dispatch component for sending, by the at least one server to the client device via the communications network, search results in respect of the search query, the search results including a group of images and at least one other image, the group of images being selected from a plurality of groups of images stored on the at least one server prior to having received the search query;
a search engine results page (SERP) dispatch component for sending, by the at least one server to the client device, instructions to cause a display to the user via a user interface of the client device of a SERP including the at least one other image and a visual representation of the group of images,
the visual representation of the group of images and the at least one other image being displayed in an array,
the visual representation of the group of images being visually distinguishable on the user interface of the client device from the at least one other image,
the visual representation of the group of images including at least one image of the group of images.

84. The system of claim 83, wherein each of the plurality of groups of images stored on the at least one server includes a plurality of similar images selected from images stored on the at least one server prior to having received the search query.

85. The system of claim 84, wherein the images stored on the at least one server have been retrieved from internet resources.

86. The system of claim 84, wherein the at least one other image is selected from the images stored on the at least server prior to having received the search query.

87. The system of claim 84, wherein each image of the images stored on the at least one server prior to having received the search query has an image identification number; and
wherein identical images have a common image identification number.

88. The system of claim 87, wherein each of the plurality of groups of images has a group identification number; and
wherein each group identification number has a plurality of corresponding image identification numbers.

89. The system of claim 87, wherein the images stored on the at least one server are stored as thumbnails.

90. The system of claim 87, wherein the images stored on the at least one server are stored with metadata associated with the images.

91. The system of claim 83, wherein the at least one image of the group of images is displayed as a thumbnail.

92. The system of claim 83, wherein the group of images is a plurality of groups of images, the visual representation of each of the plurality of groups of images being visually distinguishable on the user interface of the client device from the visual representation of a remainder of the plurality of groups of images.

93. The system of any one of claims 83 to 92, wherein the at least one other image is at least one individual image.

94. The system of claim 93, wherein the at least one individual image is displayed as a thumbnail in the array on the user interface of the client device.

95. The system of claim 93, wherein a color of the visual representation of the group of images around the at least one image of the group of images differs from a color around the at least one individual image on the SERP.

96. The system of claim 93, wherein:
the at least one image of the group of images is at least two images of the group of images;
the at least one individual image is at least two individual images; and
a spacing between the at least two images of the group of images differs from a spacing between the at least two individual images.

97. The system of claim 83, wherein the at least one other image is at least one other group of images selected from the plurality of groups of images stored on the at least one server prior to having received the search query, the at least one other group of images having a visual representation being visually distinguishable on the user interface of the client device from the visual representation of the group of images.

98. The system of claim 83, wherein the images of the group of images are visually similar.

99. The system of claim 98, wherein the images of the group of images have a similar color histogram.

100. The system of claim 98 or 99, wherein the images of the group of images have a similar histogram of gradient.

101. The system of claim 100, wherein the images of the group of images have similar prevailing colors.

102. The system of claim 98 or 99, wherein the images of the group of images have similar prevailing colors.

103. The system of claim 98, wherein the images of the group of images are of similar size and proportion.

104. The system of claim 83, wherein images of the group of images are from a single web page.

105. The system of claim 104, wherein the visual representation of the group of images includes a hyperlink to the single web page.

106. The system of claim 105, wherein the single web page has a geographical correspondence to a geographical location associated with the user interface of the client device.

107. The system of claims 83 to 91, wherein the visual representation of the group of images displays less images than a number of images present in the group of images.

108. The system of claim 107, wherein the visual representation of the group of images includes an indication of the number of images present in the group of images.

109. The system of claim 83, wherein the group of images includes at least four images.

110. The system of claim 83, wherein the visual representation of the group of images includes a banner displaying information associated with the images of the group of images.

111. The system of claim 91, wherein the at least one image of the group of images is at least two images of the group of images displayed as thumbnails.

112. The system of claim 111, wherein the at least two images are disposed side-by-side in a row.

113. The system of claim 111, wherein the at least two images of the group of images is at least three images of the group of images disposed in a tiled array.

114. The system of claim 111, wherein one of the at least two images is completely shown and other images of the at least two images are partially hidden by at least one of:
the one of the at least two images, and
another of the other images of the at least two images.

115. The system of claim 111, wherein the at least two images are arranged in a logical sequence in the visual representation.

116. The system of claim 83, wherein the images of the group of images are ranked; and
wherein the at least one image of the group of images of the visual representation of the group of images includes an image of the group of images having a highest rank.

117. The system of claim 83, wherein the search results dispatch component is for sending, by the at least one server to the client device via the communications network, the search results in respect of the search query sorted by relevancy factor.

118. The system of claim 83, further comprising a SERP display alteration component for sending, by the at least one server to the client device via the communications network, instructions to cause a change in the display of the visual representation of the group of images via the user interface of the client device to include a display of an expanded version of the group of images having been selected by the user, without leaving the SERP.

119. The system of claim 118, wherein the expanded version of the visual representation of the group of images includes at least one of the images of the group of images in full.

120. The system of claim 118, wherein the expanded version of the visual representation of the group of images at least partially overlaps at least one of the at least one other image.

121. The system of claim 83, wherein the visual representation of the group of images is a first visual representation of the group of images; and
further comprising a SERP display alteration component for sending, by the at least one server to the client device via the communications network, instructions to cause a display to the user via the user interface of the client device a second visual representation of the group of images without leaving the SERP upon receiving by the at least one server via the communications network an indication of selection of the group of images by the user on the user interface of the client device,
the second visual representation of the group of images being larger in size than the first visual representation of the group of images.

122. The system of claim 83, wherein the search results are based at least in part on metadata and image data associated with images searched by the at least one server.

123. The system of claim 83, wherein the at least one other image is at least one first other image; and
wherein the search results further include at least one second other image, the at least one second other image not being displayed on the SERP.
